(19) United States
(12) Patent Application Publication
(10) Pub. No.: US 2001/0004417 A1
(43) Pub. Date: Jun. 21, 2001

(54) Video editing system

(76) Inventors: Ageishi Narutoshi, Ichinomyashi (JP); Kameyama Ken, Aichiken (JP); Kajimoto Kazuo, Neyagawa-shi (JP)

Correspondence Address: Joseph W. Price, PRICE, GESS & UBELL, Ste. 250, 2100 S.E. Main St., Irvine, CA, 92614, US

(21) Appl. No.: 09/745,142

(22) Filed: Dec. 20, 2000

(30) Foreign Application Priority Data
Dec. 21, 1999 (JP) 11-362361
Nov. 28, 2000 (JP) 2000-361987

(51) Int. Cl. H04N 5/93; G11B 27/00

(52) U.S. Cl. 386/52; 386/64

(57) ABSTRACT

A nonlinear editing server 1 receives video editing information, which is then analyzed by an audio/video (AV) data managing unit 14. In accordance with the analyzed video editing information, AV data specified in the video editing information is read and sent to at least one of decoders 121 and 122 to be reproduced. An AV data processing unit 123 performs editing for the reproduced AV data based on the video editing information and generates a single AV stream. An encoder 124 encodes this AV stream. The nonlinear editing server 1 then transmits the encoded AV stream to a nonlinear editing client. In this way, the nonlinear editing server 1 only transmits a single AV stream to a nonlinear editing client.

### BACKGROUND OF THE INVENTION

(1) Field of the Invention

The present invention relates to a video editing system containing a plurality of devices that are connected via a network and that edit video data.

(2) Description of the Prior Art

A nonlinear editing device containing a computer, hard disk, and the like has been used in the field of broadcast and other fields. This nonlinear editing device obtains and stores a plurality of pieces of audio data and video data (hereafter the audio and video data is collectively called “AV (audio-video) data”), and edits stored AV data in accordance with the content of a program to be broadcasted.

The following first describes a conventional nonlinear editing device achieved by a single computer as the first conventional technique with reference to FIG. 1, and then a nonlinear editing system achieved by a plurality of computers that are connected via a network as the second conventional technique with reference to FIG. 2.

FIG. 1 is a block diagram showing an overall construction of the nonlinear editing device of the first conventional technology. In this nonlinear editing device, a storing unit 255 stores, in advance, AV data in predetermined formats such as a DVCPRO format and an MPEG (Moving Picture Expert Group) format.

A user specifies information such as an order of arrangement of pieces of video data, and a method used to have a transition occur between different pieces of video data, using an operation inputting unit 251 and an editing work display unit 253. The operation inputting unit 251 inputs information relating to editing, and the editing work display unit 253 displays data relating to the editing. In accordance with the inputted information, a video editing information generating unit 252 generates video editing information. Based on the generated video editing information, an AV data managing unit 254 instructs to read each necessary piece of AV data from the storing unit 255. A video effect producing unit 256 then adds a video effect to pieces of AV data that have been read, so that effect-added AV data is generated. The effect-added AV data is displayed by an editing video display unit 257 and recorded onto a magnetic tape loaded into a video recorder 258. AV data recorded on the magnetic tape is then used for a broadcast.

The video effect producing unit 256 contains two decoders 261 and 262 for decoding AV data and an AV data processing unit 263 for processing the decoded AV data. For a single piece of video data decoded by one of the two decoders 261 and 262, the AV data processing unit 263 performs a video effect addition such as by changing a color of parts of the piece of video data or by performing the so-called mosaic tiling processing, fade-in processing, or fade-out processing, so that a transition is made between different images contained in the piece of video data. For two pieces of video data that have been decoded in parallel by the decoders 261 and 262, the AV data processing unit 263 combines these pieces of video data by adding video effects such as a wipe and a dissolve to have transition made from one piece of video data to the other, or by generating a picture-in-picture image from the two pieces of video data. With a wipe, one image is superimposed on the other image from right to left, or top to bottom, for instance. With a dissolve, a density of one displayed image is changed gradually to have a transition made from this image to another image. With a picture-in-picture, one smaller image, whose size has been reduced from its original size, is displayed on a larger image.

Unlike the nonlinear editing device of the first conventional technology, the nonlinear editing system of the second conventional technology has a single computer (a nonlinear server) manage AV data collectively, and has a plurality of computers (nonlinear editing client) edit the AV data stored in the nonlinear server in remote control.

FIG. 2 is a block diagram showing an overall construction of this nonlinear editing system. This nonlinear editing system comprises a nonlinear editing server 6 that collectively manages AV data, a plurality of nonlinear editing clients such as clients 7 and 8 that are used by a plurality of users, and a network 9 which is connected to the nonlinear editing server 6 and the plurality of nonlinear editing clients to transfer necessary data. In FIG. 2, the same reference number as used in FIG. 1 is assigned to an element that is basically the same as in FIG. 1.

A user of the nonlinear editing client 7 (or any of 410 the plurality of nonlinear editing clients) inputs information relating to AV data editing, using an operation inputting unit 71 and an editing work display unit 72. A video editing information generating unit 73 then generates video editing information in accordance with the inputted information. The generated video editing information is then transmitted to an AV data managing unit 61 in the nonlinear editing server 6. Based on the transmitted video editing information, the AV data managing unit 61 reads AV data from the storing unit 62, and the read AV data is transferred to the nonlinear editing client 7.

A video effect producing unit 74 in the nonlinear editing client 7 contains two decoders 741 and 742 and an AV data processing unit 743. The video effect producing unit 74 decodes the transferred AV data, and adds a video effect like that added in the first conventional technology to the decoded AV data to generate effect-added AV data. The effect-added AV data is then displayed by the edited video display unit 75 and/or recorded onto a magnetic tape loaded into a video recorder 76.

This nonlinear editing system manages AV data more efficiently than the nonlinear editing device of the first conventional technology.

However, the cost of a video effect producing unit like the unit 74 contained in a standard nonlinear editing system is high, and therefore the total cost of the nonlinear editing system highly increases in accordance with the total number of nonlinear editing clients contained therein.

In addition, with the conventional nonlinear editing system, it is necessary to provide a construction to perform a video effect addition or a video data combining to every editing client whenever a video effect adding method or an image combining method is developed. In this way, the conventional video editing system cannot flexibly respond to such newly-developed editing methods.

### SUMMARY OF THE INVENTION

The present invention is made in view of the above problems, and aims to provide a video editing system whose production cost is reduced and which can flexibly respond to an addition of a newly-developed editing method.

The above objects can be achieved by an editing server included in an audio/video (AV) editing system, which includes a plurality of clients that are connected via a network to the editing server. The editing server includes: an editing information receiving unit for receiving editing information from a client out of the plurality of clients, wherein the editing information specifies at least one AV stream, at least one frame contained in the at least one AV stream, and an editing operation which contains at least one of (a) a combining of each specified frame, and (b) an addition of a special effect to each specified frame; an AV stream obtaining unit for obtaining each specified AV stream; an editing unit for performing the editing operation for the obtained AV streams in accordance with the received editing information; and a transmitting unit for transmitting each AV stream, for which the editing operation has been performed, to the client.

For this construction, the editing server edits AV streams, and therefore it is unnecessary to provide a special device to perform the editing to each client. This reduces a production cost of the whole editing system, and allows the editing system to flexibly respond to a new editing method for producing a special effect or combining images since the new editing method can be supported by only providing a device supporting the new editing method to the editing server.

Here, the above editing server may further include an AV stream storing unit for storing at least one AV stream. When the received editing information specifies at least two AV streams, at least two video frames in the at least two AV streams, and the combining as the editing operation, the AV stream obtaining unit may read the at least two specified AV streams from the AV stream storing unit. The editing unit may perform the editing operation by combining the at least two specified video frames contained in the at least two read AV streams to generate an AV stream.

Unlike a conventional editing system in which a plurality of AV streams to be combined are transmitted from an editing server to a client, the above editing server combines a plurality of AV streams into a single AV stream, and transmits this AV stream to a client. As a result, the load of the network can be reduced.

Here, as a result of the combining, the editing unit may generate a combined video frame and reduce a resolution of the combined video frame.

For this construction, an AV stream of a reduced data size is transmitted via a network to a client. This reduces the load of the network and the load of the client decoding the transmitted AV stream.

Here, the above editing server may further include an AV stream storing unit for storing at least one AV stream. When the received editing information specifies the addition as the editing operation, the AV stream obtaining unit may read the at least one specified AV stream from the AV stream storing unit. The editing unit may perform the editing operation by adding a special effect to each specified frame contained in the at least one read AV stream.

For this construction, the editing server collectively manages AV streams, and adds a special effect to an AV stream in accordance with editing information transmitted from a client. This allows a client to instruct the editing server to edit an AV stream stored by the editing server.

Here, when the received editing information specifies the addition as the editing operation, the AV stream obtaining unit may receive the at least one specified AV stream from the client who sends the editing information. The editing unit may perform the editing operation by adding a special effect to each specified frame contained in the at least one received AV stream.

With this construction, the editing server adds a special effect to an AV stream, which was originally stored in each client. This allows, for instance, a user to input an AV stream recorded by him with a video camera to a client, which then transmits the AV stream to the editing server. In this way, the editing server can add a special effect to an AV stream which was recorded by the user.

Here, the plurality of clients may each include: an editing information generating unit for generating editing information, which may specify at least one AV stream, at least one frame contained in the at least one AV stream, and an editing operation which contains at least one of (a) a combining of each specified frame and (b) an addition of a special effect to each specified frame; an editing information transmitting unit for transmitting the generated editing information to the editing server; a stream receiving unit for receiving an AV stream, for which the editing operation has been performed, from the editing server; and a reproducing unit for reproducing the received AV stream.

This achieves an AV editing system, whose production cost is reduced and which can flexibly respond to a newly-developed editing method.

The above objects can be also achieved by an editing server included in an audio/video (AV) editing system, which includes a content server and a plurality of clients, wherein the editing server, the content server, and the plurality of clients are connected via a network. The editing server includes: an editing information receiving unit for receiving editing information and a client number from the content server, wherein the editing information specifies at least one AV stream and at least one frame contained in the at least one AV stream, and contains an instruction to perform at least one of (a) a combining of each specified frame, and (b) an addition of a special effect to each specified frame, wherein the client number specifies a client to which an AV stream, for which the editing operation has been performed, is to be transmitted; an AV stream receiving unit for receiving each specified AV stream from the content server, which stores an AV stream; an editing unit for extracting the instruction from the received editing information, and performing, for the received AV streams, at least one of the combining and the addition in accordance with the extracted instruction; and a transmitting unit for transmitting each AV stream, for which at least one of the combining and the addition has been performed, to the client specified by the client number.

For this construction, the editing server only performs operations that involve frames to be edited in accordance with an instruction, and does not perform any operations that involve frames for which editing is not performed. As a result, the load of the editing server can be reduced.

The above objects can be also achieved by a content server included in an audio/video (AV) editing system, which includes an editing server and a plurality of clients, wherein the editing server, the content server, and the plurality of clients are connected via a network. The content server includes: an AV stream storing unit for storing at least one AV stream; an editing information receiving unit for receiving editing information from a client out of the plurality of clients, wherein the editing information specifies at least one AV stream, at least one frame contained in the at least one AV stream, and an editing operation which contains at least one of (a) a combining of each specified frame, (b) an addition of a special effect to each specified frame, and (c) a transmission of each specified frame; and a transmitting unit for reading each specified frame from the AV stream storing unit, transmitting the read frame to the editing server if the specified editing operation is at least one of the combining and the addition, and transmitting the read frame to the client if the specified editing operation is the transmission.

With this construction, the content server transmits frames for which editing is unnecessary directly to a client. The load of the editing server can be therefore more reduced in comparison with an editing server that performs operations required to transmit all the frames.

The above objects can be also achieved by an audio-video (AV) editing system which comprises a plurality of clients, the above editing server, and the above content server, all of which are connected via a network. The plurality of clients each include: an editing information generating unit for generating the editing information, which specifies at least one AV stream, at least one frame contained in the at least one AV stream, and an editing operation which contains at least one of (a) a combining of each specified frame, (b) an addition of a special effect to each specified frame, and (c) a transmission of each specified frame; an editing information transmitting unit for transmitting the generated editing information to the content server; a receiving unit for receiving an AV stream from one of the editing server and the content server; and a reproducing unit for reproducing the received AV stream.

This can achieve an AV editing system in which the processing load is shared by the editing server and the content server.

The above objects can be also achieved by an editing server included in an audio/video (AV) editing system, which includes a plurality of editing clients connected via a network to the editing server, wherein each editing client performs editing for an AV stream by executing a script. The editing server includes: a script storing unit for storing a group of scripts that each describe a processing content for producing a special effect of a different type; a script request receiving unit for receiving a request for a script from a client out of the plurality of clients, the request designating a type of the script; and a script transmitting unit for reading the script of the designated type from the script storing unit, and transmitting the read script to the client.

For this construction, each editing client obtains a script which is collectively stored and managed by the editing server. The editing client then executes the obtained script on an AV stream, and obtains an effect-added AV stream. Accordingly, each editing client does not need to contain a different device dedicated to producing a special effect of each type. In addition, a script for a newly-developed special effect becomes available for every editing client by only registering the new script into the editing server.

Here, the above editing server may further include: a script list request receiving unit for receiving a request for a script list from an editing client out of the plurality of editing clients, the script list showing information regarding the group of scripts stored in the script storing unit; a script list storing unit for storing the script list; and a script transmitting unit for reading the script list from the script list storing unit in response to the received request, and transmitting the read script list to the editing client.

This construction allows each editing client to know information regarding all the scripts stored in the editing server by obtaining a script list before requesting a script.

Here, the above editing server may further include: a sample data generating unit for reading a script from the script storing unit, and having the read script executed on a predetermined AV stream to generate sample data; a sample data request receiving unit for receiving a request for sample data from an editing client out of the plurality of editing clients, the request designating a type of a script; and a sample data transmitting unit for transmitting, to the editing client, the sample data generated by having the script of the designated type executed.

For this construction, each editing server can designate a script type to obtain sample data, which is to be generated by executing the designated script on a predetermined AV stream. This allows a user of an editing client to view a result of execution of a desired script before selecting the script.

Here, the editing server may further include: a preview data request receiving unit for receiving a request for preview data from an editing client out of the plurality of editing clients, the request containing an AV stream and designating a type of a script; a preview data generating unit for reading the script of the designated type from the script storing unit, and executing the read script on the AV stream contained in the received request to generate preview data; and a preview data transmitting unit for transmitting the generated preview data to the editing client.

For this construction, a user of each editing client can designate a script type and obtain preview data generated by executing the designated script on an AV stream he has recorded. This allows the user to view a result of execution of a desired script before selecting the script.

Here, the AV editing system may further include a script generating client connected via the network to the editing server. The editing server may further include: a registration request receiving unit for receiving a script from the script generating client; and a script placing unit for placing the received script into the script storing unit.

With this construction, the editing server receives a script from the script generating client via the network, and stores the received script. The editing server then transmits a stored script to an editing client if a user of the editing server requests this script. In this way, the present editing server can efficiently and easily distribute a newly-generated script.

Here, the editing server may further include: a usage information storing unit for storing usage information which associates each script stored in the script storing unit with an identifier (ID) of a provider who has transmitted the script, and with an ID of a user who has received the script; and a charging information generating unit for generating, based on the usage information, charging information which associates each script stored in the script storing unit with a first fee paid to a provider of the script and a second fee charged to a user of the script.

For this construction, a fee charged to a user of a script and a fee paid to a provider of the script can be automatically calculated. This facilitates distribution of scripts.

Here, when the usage information associates a script with a larger total number of IDs of users, the charging information generating unit may generate the charging information associating the script with a larger first fee and a larger second fee.

With this construction, a charging fee of a script is determined in accordance with how many times the script has been used. As a result, each script can be suitably distributed.

The above objects can be also achieved by an audio-video (AV) editing system which includes a plurality of editing clients, the above editing server, and a script generating client. The editing server is connected via a network to the script generating client and each editing client. Each editing client performs editing for an AV stream by executing a script and includes: a transmitting unit for transmitting a request for a script to the editing server, the request designating a type of the script; and a receiving unit for receiving the script of the designated type from the editing server. The script generating client includes: a script generating unit for generating a script that describes a processing content for producing a special effect of one type; and a script transmitting unit for transmitting the generated script to the editing server.

For this construction, an editing client does not need to have a different device dedicated to producing a special effect of each type. When a method for producing a new special effect is developed, every editing client can use this new special effect by merely having a script for the new special effect registered in the editing server.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing an overall construction of a nonlinear editing device of the first conventional technology;

FIG. 2 is a block diagram showing an overall construction of a nonlinear editing system of the second conventional technology;

FIG. 3 is a block diagram showing an overall construction of a nonlinear editing system of the first embodiment;

FIG. 4 shows how data is transferred via a network 5;

FIG. 5 shows an example of video editing information;

FIG. 6 shows a diagrammatic representation of the example video editing information shown in FIG. 5;

FIGS. 7A-7C show how a wipe transition from one piece of video data to another is made as one example;

FIG. 8 is a flowchart showing the processing of nonlinear editing clients 2-5;

FIG. 9 is a flowchart showing the processing of a nonlinear editing server 1;

FIG. 10 is a block diagram showing an overall construction of a modified nonlinear video editing system;

FIG. 11 shows an example construction that contains dedicated units that each perform a video effect addition or an image combining of a different type;

FIG. 12 shows an example construction achieved by a general-purpose processing device that executes an effect script;

FIG. 13A shows a construction of AV files “A” and “B” which are specified in video editing information;

FIG. 13B shows a data flow of a nonlinear editing system of the second embodiment;

FIG. 14 is a block diagram showing a construction of the nonlinear video editing system;

FIG. 15 is a flowchart showing the processing of the nonlinear video editing system;

FIG. 16 is a block diagram showing a construction of a nonlinear video editing system of the third embodiment;

FIG. 17 is a block diagram showing a construction of an effect script generating device 200;

FIG. 18A shows a registration request message;

FIG. 18B shows a message requesting an effect script list;

FIG. 18C shows a message requesting sample data;

FIG. 18D shows a message requesting an effect script;

FIG. 18E shows a message requesting sample data;

FIG. 19 shows a construction of a nonlinear editing client 300;

FIG. 20 is a block diagram showing a construction of a nonlinear editing server 100;

FIG. 21 shows an example of effect script management information;

FIG. 22 shows an example of an effect script list;

FIG. 23 shows a procedure to have an effect script generating device 200 transmit an effect script to the nonlinear editing server 100 and to have the nonlinear editing server 100 register the transmitted effect script;

FIG. 24 shows a procedure to transfer an effect script list from the nonlinear editing server 100 to the nonlinear editing client 300;

FIG. 25 shows a procedure to transfer sample data from the nonlinear editing server 100 to the nonlinear editing client 300;

FIG. 26 shows a procedure to transfer an effect script from the nonlinear editing server 100 to the nonlinear editing client 300; and

FIG. 27 shows a procedure to transfer preview data from the nonlinear editing server 100 to the nonlinear editing client 300.

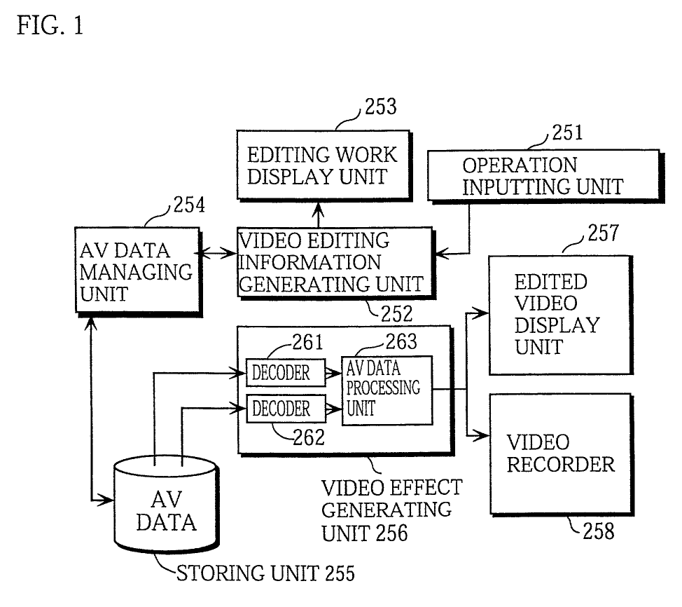

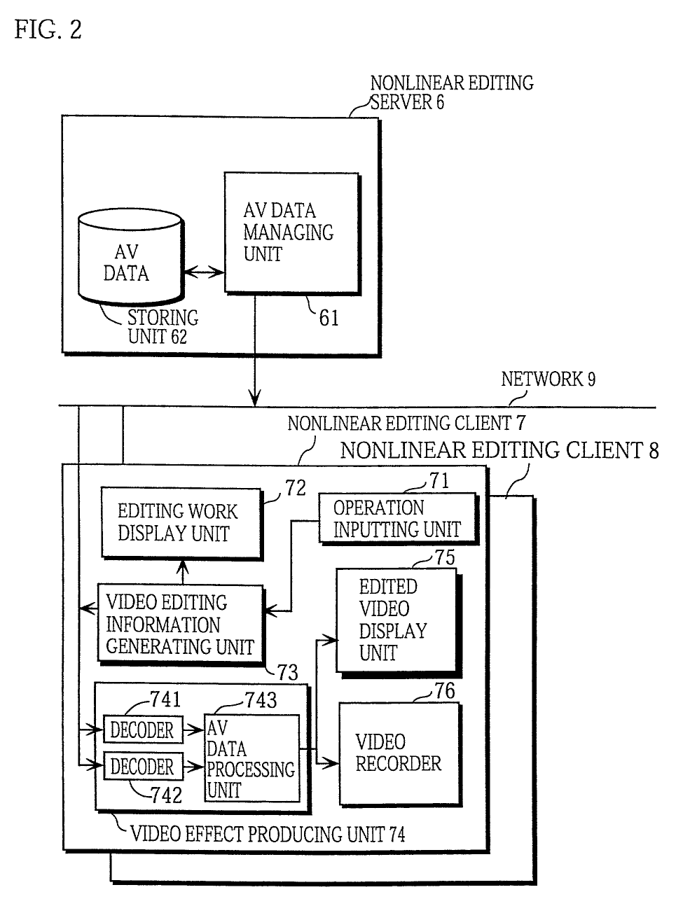

### DESCRIPTION OF THE PREFERRED EMBODIMENTS

The following describes the present invention using several embodiments.

### First Embodiment

The present embodiment describes a nonlinear video editing system including a video editing server that performs a video effect addition and an image combining.

### Construction

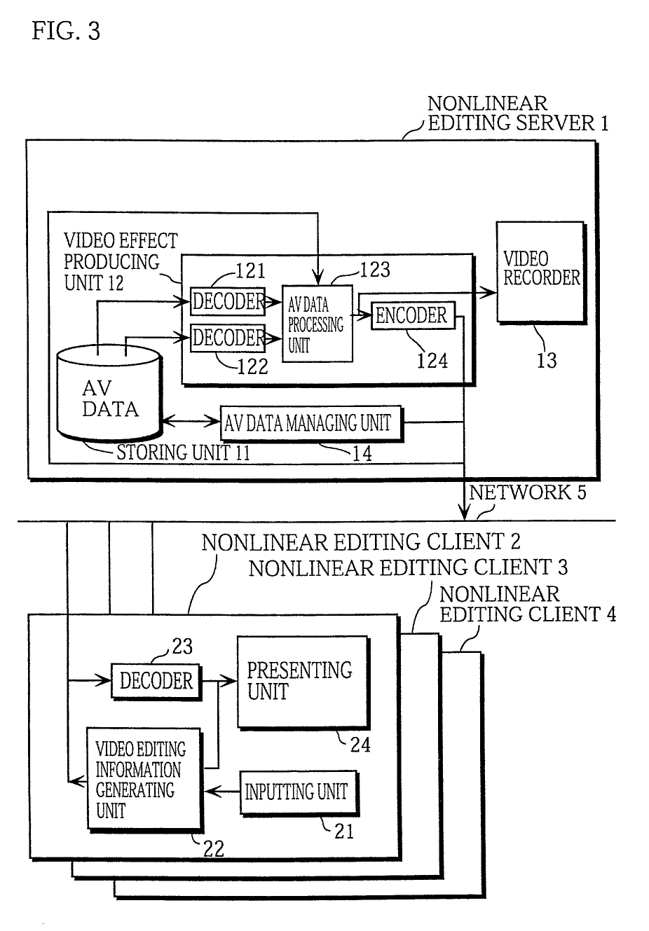

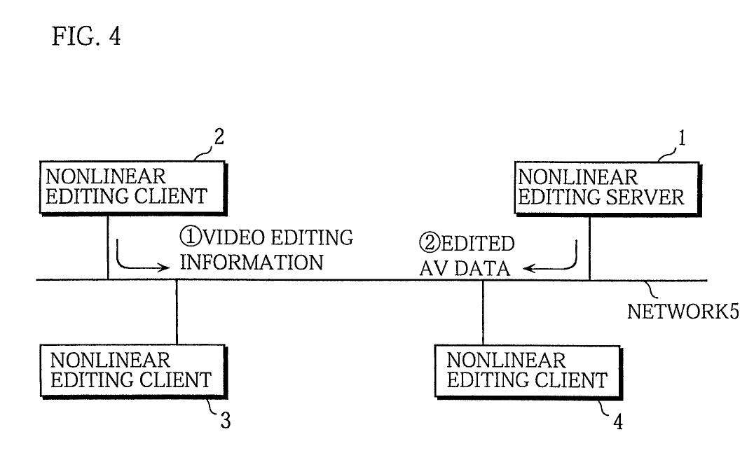

FIG. 3 is a block diagram showing an overall construction of the nonlinear editing system of the present embodiment, and FIG. 4 shows how data is transferred via a network 5.

As shown in FIG. 3, the present nonlinear editing system comprises a nonlinear editing server 1, nonlinear editing clients 2-4, and a network 5. The nonlinear editing server 1 stores and collectively manages AV data, and edits AV data in accordance with video editing information generated by the nonlinear editing clients 2-4. The nonlinear editing clients 2-4 generate video editing information, and present AV data edited by the nonlinear editing server 1. Data is transferred between the nonlinear editing server 1 and the nonlinear editing clients 2-4 thorough the network 5, which includes units (not shown in the figure) that are required for this data transfer.

The nonlinear editing server 1 includes the following elements: a storing unit 11; a video effect producing unit 12; a video recorder 13; and an AV data managing unit 14. The storing unit 11 stores AV data in a predetermined formats. The video effect producing unit 12 performs video editing, such as a video effect addition or an image combining. For a single piece of video data, the video effect producing unit 12 performs video editing by changing a color of parts of the piece of video data, or performing the so-called mosaic tiling or the like. For two pieces of video data, the video effect producing unit 12 combines the pieces of video data by adding video effects such as a wipe and a dissolve to have a transition made from one piece of video data to the other, by generating a picture-in-picture image from the two pieces of video data, or by performing other operations. The video effect generating unit 12 also adds a sound effect to audio data. The above video effect and sound effect may be called a special effect. The video recorder 13 records, if necessary, the edited AV data onto a recording medium, such as a magnetic tape, which is loaded inside the recorder 13. The AV data managing unit 14 manages AV data in the storing unit 11 and controls a read from and a write into the storing unit 11.

In more detail, the video effect producing unit 12 contains two decoders 121-122, an AV data processing unit 123, and an encoder 124.

The decoders 121-122 decode the AV data stored in the storing unit 11. The AV data processing unit 123 performs editing as described above for the decoded AV. The encoder 124 encodes the edited AV data into data in predetermined formats which may or may not be the same as the aforementioned predetermined formats.

The nonlinear editing clients 2-4 each include an inputting unit 21, a video editing information generating unit 22, a decoder 23, and a presenting unit 24.

The inputting unit 21 inputs data relating to video data editing. The video editing information generating unit 22 generates video editing information in accordance with the inputted data. The decoder 23 is capable of decoding AV data encoded by the encoder 124 of the nonlinear editing server 1. The presenting unit 24 presents the above data inputted via the inputting unit 21, and the AV data that has been decoded by the decoder 23.

As shown in FIG. 4, the nonlinear editing client 2 (and the nonlinear editing clients 3-4) transmits video editing information, which has been generated in accordance with the data inputted by the user via the inputting unit 21, to the nonlinear editing server 1. Based on this video editing information, the nonlinear editing server 1 performs video editing for AV data, encodes the edited AV data to generate encoded AV data again, and transfers the encoded AV data to the nonlinear editing clients 2-4. The nonlinear editing clients 2-4 decode and present the transferred AV data in real time.

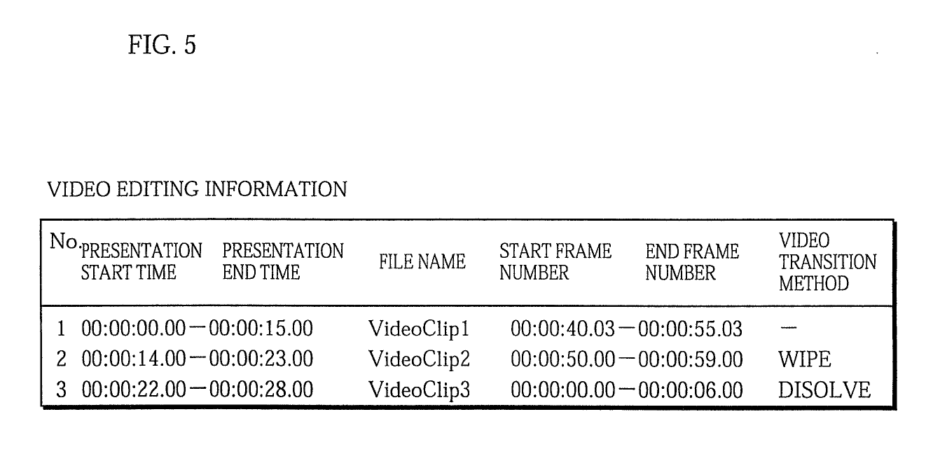

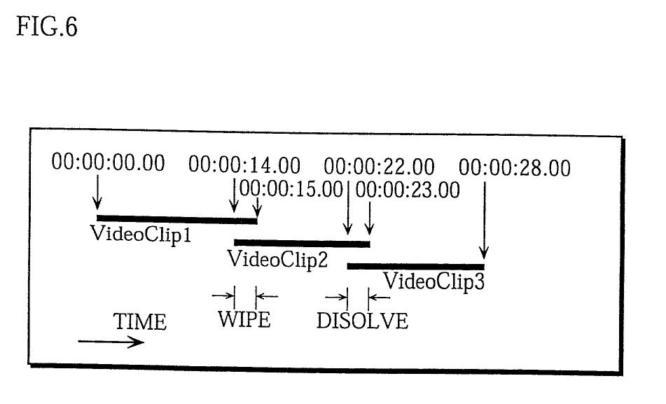

The present nonlinear editing system uses video editing information as shown in FIGS. 5 and 6.

FIG. 5 shows an example of the video editing information, and FIG. 6 shows a diagrammatic representation of the example video editing information in FIG. 5. The user views video editing information in the form of FIG. 6 while inputting necessary data.

As shown in FIG. 5, the video editing information contains the following six items: a presentation start time showing a time to start presenting certain AV data; a presentation end time showing a time to end this AV data presentation; a file name specifying a name of a file, which stores this certain AV data; a start frame number specifying an AV frame arranged at the start of AV frames that are stored in the above file and that correspond to the certain AV data; an end frame number specifying an AV frame at the end of the above frames correspond to the certain AV data; and a video transition method showing a method used to have a transition occurred from one piece of video data to the other.

For the presentation start time, the presentation end time, the start frame number, and the end frame number, “:” is used to demarcate hours, minutes, and seconds from one another, and “.” is used to demarcate a time (i.e., the hours, minutes, and seconds) from a frame number. The start frame number and the end frame number are assigned on the assumption that a frame at the start of a file specified in each file name is assigned a frame number “00:00:00.00” and that thirty AV frames are presented per second. “VideoClip1”, “VideoClip2”, and “VideoClip3” are the file names. These files are stored in the storing unit 11, and each of the files store AV data (frames) corresponding to one AV data stream.

“WIPE” and “DISSOLVE” are video transition methods and indicate that a transition from one image to another is made by a wipe and a dissolve, respectively.

FIG. 6 shows how AV data is presented according to the video editing information shown in FIG. 5. From a time “00:00:00.00” to a time “00:00:15.00”, AV data in the “VideoClip1” file is presented. From a time “00:00:14.00” to a time “00:00:23.00”, AV data in the “VideoClip2” file is presented. From a time “00:00:22.00” to a time “00:00:28.00”, AV data in the “VideoClip3” file is presented. For one second from a time “00:00:14.00” to a time “00:00:15.00”, a wipe transition is made from the “VideoClip1” file to the “VideoClip2” file. For one second from a time “00:00:22.00” to a time “00:00:23.00”, a dissolve transition is made from the “VideoClip2” file to the “VideoClip3” file.

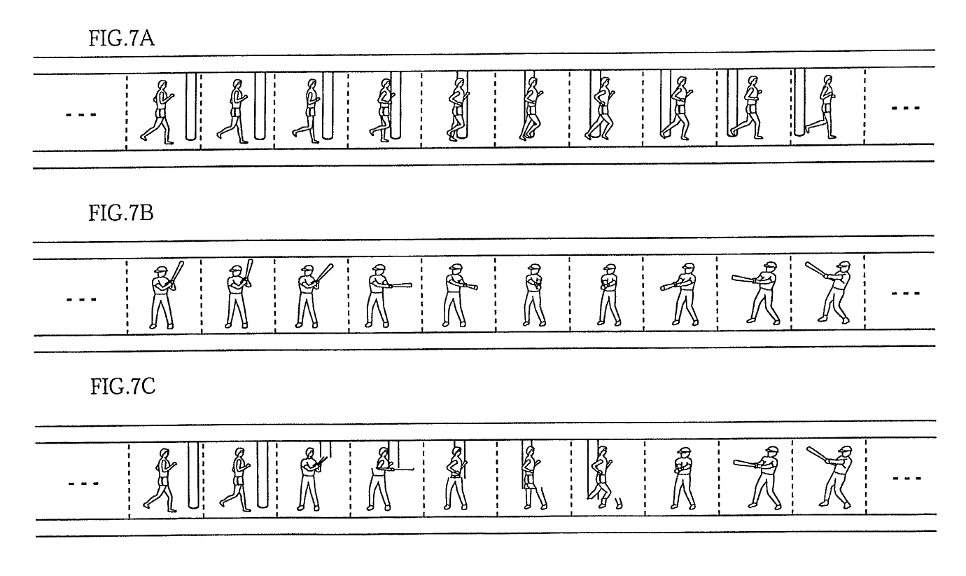

FIG. 7 shows how a wipe transition from a piece of video data to another is made as one example. As shown in the figure, images in video data 2 are superimposed on images in video data 1 from top to bottom in order.

### Operations

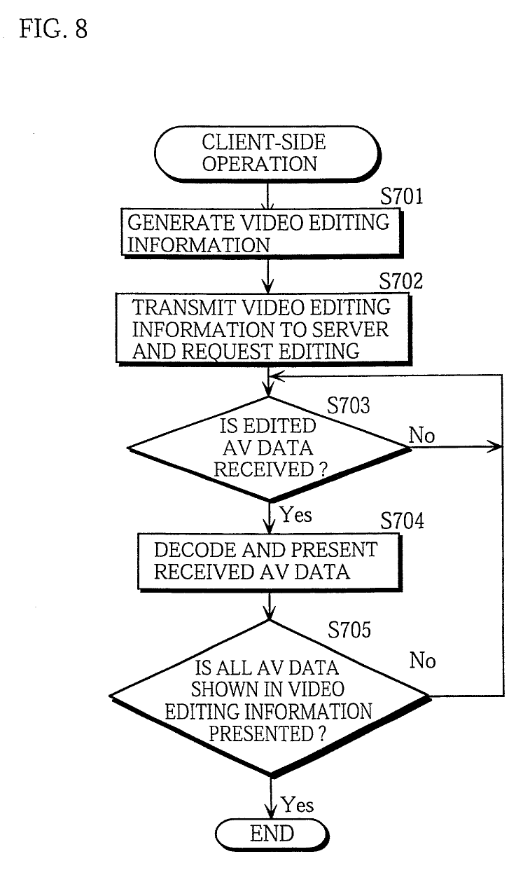

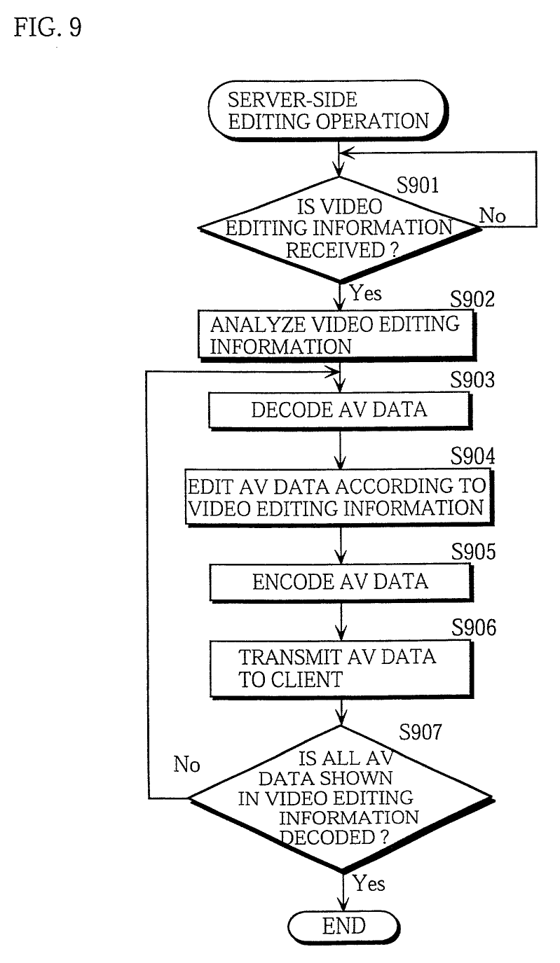

The nonlinear editing clients 2-4, and the nonlinear editing server 1 perform editing processing as shown in flowcharts of FIGS. 8 and 9.

The following describes the processing of the nonlinear editing clients 2-5 with reference to FIG. 8 on the assumption that a user of the nonlinear editing client 2 wishes video editing.

When the user desires video editing, he inputs information relating to the video editing, using the inputting unit 21 and the presenting unit 24, so that the video editing information generating unit 22 generates video editing information as described above (step S701). The nonlinear editing client 2 then transfers the generated video editing information to the nonlinear editing server 1, and requests editing of AV data according to the video editing information (step S702). After this, the nonlinear editing client 2 judges whether it has received AV data edited according to the video editing information (step S703). If not, reception of the AV data continues to be awaited. If so, the control flow moves to step S704.

In step S704, the decoder 23 decodes the judged AV data, and the presenting unit 24 presents the decoded AV data. Following this, the nonlinear editing client 2 judges whether all the AV data shown in the video editing information has been presented (step S705). If not, the control flow moves to step S703. If so, the processing is terminated.

The following describes the processing of the nonlinear editing server 1 with reference to FIG. 9. The editing server 1 judges whether it has received the video editing information, which the nonlinear editing client 2 has transmitted in step S702 (step S901). If not, the reception of the video editing information is awaited again. If so, the AV data managing unit 14 in the editing server 1 analyzes the received video editing information (step S902).

In accordance with the analyzed video editing information, AV data shown in the received video editing information is read from the storing unit 11 into either one or both of the decoders 121 and 122, which then decodes the read AV data (step S903). The AV data processing unit 123 performs editing on the decoded AV data according to the video editing information (step S904), and then the encoder 124 encodes the edited AV data (step S905), which is then transmitted to the nonlinear editing client 2 (step S906). (On receiving this AV data, the nonlinear editing client 2 would perform operations, such as step S704 described above.)

Following this, the nonlinear video editing server 1 judges whether it has decoded all the AV data shown in the video editing information (step S907). If not, the control flow moves to step S903. If so, the processing is terminated.

### Considerations

With the above nonlinear video editing system, the nonlinear editing clients 2-4 each generate video editing information in accordance with data inputted from the user, and transmit the generated video editing information to the nonlinear editing server 1. In accordance with this video editing information, the nonlinear editing server 1 simultaneously edits a plurality of pieces of AV data to allow them to make a wipe or dissolve transition, or to reproduce them as a picture-in-picture image. The nonlinear editing server 1 then encodes edited AV data, and transmits the encoded AV data to each of the nonlinear editing clients 2-4 which have generated the video editing information. The nonlinear editing clients 2-4 then decode and present the transmitted AV data.

Accordingly, the present nonlinear video editing system has the following advantages.

First, the present nonlinear editing clients 2-4 can have a more simple construction than a conventional client since the present editing clients 2-4 only need to decode and present AV data without having to edit AV data. If the encoder 124 in the nonlinear editing server 1 encodes AV data according to a standard prescribed in, for instance, Motion-JPEG (Joint Photographic Experts Group), an ordinary PC (personal computer) can be used as a nonlinear editing client only by having software installed into the PC without special hardware being added to the PC. This reduces the cost of each nonlinear editing client, so that an overall cost of a nonlinear video editing system can be reduced.

Secondly, the video editing system of the present embodiment can flexibly support a newly-developed image combining method and a new effect addition method by only providing a construction to achieve the image combining and the effect addition to the nonlinear editing server 1.

With the nonlinear editing system of the second conventional technology, the nonlinear editing server 6 needs to transfer a plurality of pieces of AV data simultaneously to the nonlinear editing client 7 via the network 9 when a user wishes to combine these different pieces of AV data into a single piece of AV data in real time. This is to say, the load of the network 9 considerably increases in accordance with a total size of the plurality of pieces of AV data to be transferred to be combined.

For the present nonlinear video editing system, however, the nonlinear editing server 1 transmits, to the client side, edited AV data corresponding to a single piece of video data generated from a plurality of pieces of video data, unlike the conventional server 6, which transmits AV data corresponding to a plurality of pieces of video data which have not been edited. With the present nonlinear video editing system, the load of a network can be therefore reduced. For instance, when each piece of AV data in the storing unit 11 is encoded in a format prescribed in the DVCPRO50 standard, transmission of one piece of this AV data requires a transmission bandwidth of about 50 Mbps. The conventional nonlinear editing system therefore requires a 100 Mbps bandwidth for the network 9 to transmit two pieces of AV data such as when two pieces of AV data should be combined as a picture-in-picture image. The present nonlinear editing system, however, requires only a 50 Mbps bandwidth for one piece of AV data even when a plurality of pieces of AV data should be combined.

Lastly, the present nonlinear video editing system allows the nonlinear editing clients 2-4 to use a decoding method that is compatible with only an encoding method used by the encoder 124 in the nonlinear editing server 1, regardless of a format of AV data stored in the storing unit 11. Accordingly, it is possible to store AV data in a DVCPRO format in the storing unit 11, have the decoders 121 and 122 support this format, and have the encoder 124 on the server side and the decoder 23 on the client side support an MPEG format. This allows the storing unit 11 to store high-quality AV data compressed at a low compression rate, and the network 5, the encoder 124, and the decoder 23 to use low-quality AV data compressed at a high compression, so that AV data can be efficiently used in the present nonlinear editing system. Moreover, when a format of AV data in the storing unit 11 has been changed, the present nonlinear editing system can respond to this change by only changing decoders 121 and 122 on the server side without the decoder 23 (or a program corresponding to the decoder 23) contained in every nonlinear editing client needing to be changed.

### Example Modifications

The following describes example modifications to the nonlinear video editing system of the above embodiment.

(1) Reduction in Image Size

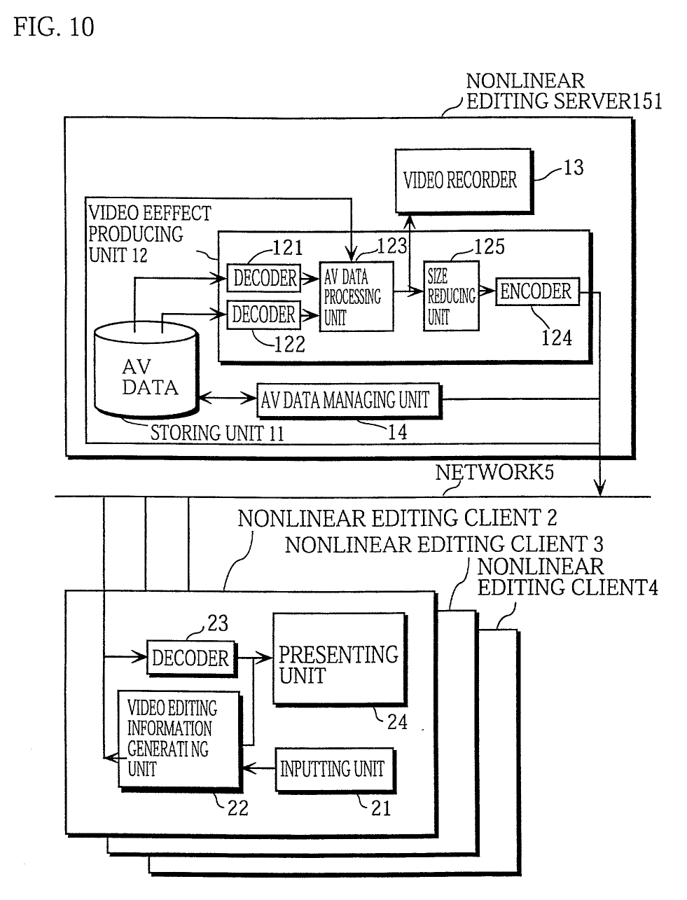

FIG. 10 is a block diagram showing an overall construction of a modified nonlinear video editing system. This modified video editing system differs from the first embodiment in that a video effect producing unit 12 of the modified editing system additionally contains a size reducing unit 125. Other elements of the two nonlinear video editing systems are the same, and so will not be described.

In prior to encoding by the encoder 124, the size reducing unit 125 reduces a size of decoded AV data. Resulting AV data has a smaller size and a lower resolution than the AV data in the first embodiment. This reduces the load of the network 5 and that of the nonlinear editing clients 2-4 decoding the transferred AV data. When the size reducing unit 125 reduces a length and a width of each image to half the original and the encoder 124 encodes this video image according to, for instance, Motion-JPEG, a data size of this Motion-JPEG video data can be reduced to one-fourth the original data size. A size of audio data in AV data can be reduced by lowering a sampling frequency.

(2) Number of Pieces of AV Data

In the first embodiment, the nonlinear video editing system is described as having two decoders to allow the video effect producing unit 12 to perform editing using two pieces of video data. However, the video effect producing unit 12 may perform editing using three or more pieces of AV data by having decoded AV data temporarily stored or by providing three decoders to the nonlinear editing server 1.

Note that the nonlinear video editing system of the present embodiment has an advantage even when video editing such as a fade-in processing and a fade-out processing, is performed on only a single piece of AV data although the above describes an advantage of a reduced load of a network, which is obtained when two pieces of AV data are combined. This is to say, since the nonlinear editing server of the present embodiment collectively performs AV data editing, the present video editing system has advantages in that a nonlinear editing client can have a simple construction and that it can respond to a newly-developed video effect addition method or the like by merely adding a function to perform this video effect processing to the video editing server.

(3) Video Effect Addition Operation

The above embodiment omits a detailed explanation of the AV data processing unit 123 in the video effect producing unit 12. The following describes two possible construction examples of the AV data processing unit 123.

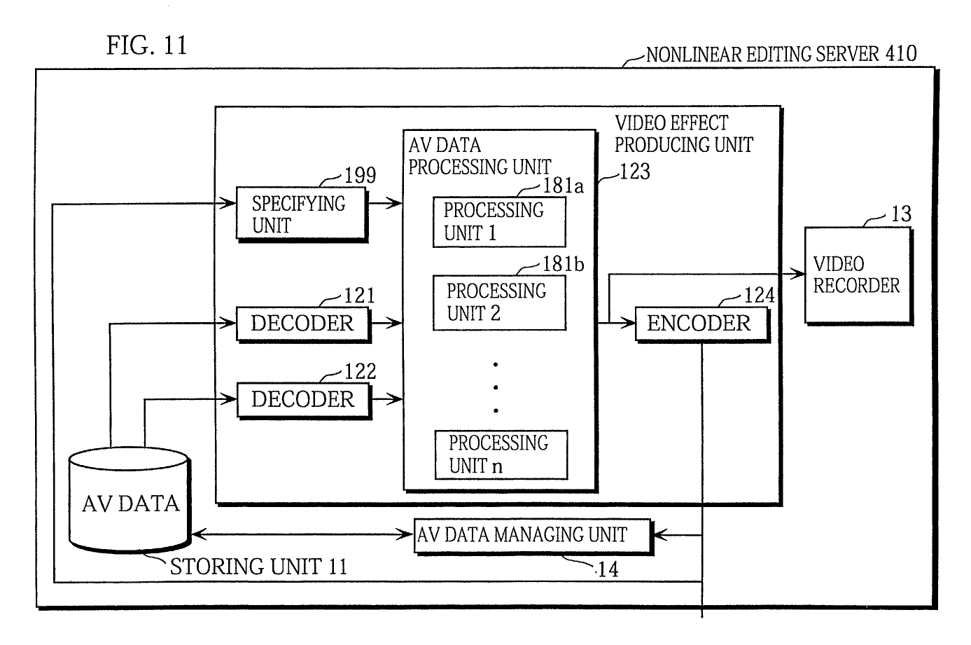

FIG. 11 shows an example construction of the AV data processing unit 123 that contains processing units, such as a unit 181a, that each perform a video effect addition or an image combining of a predetermined type. A specifying unit 199 specifies a type of a video effect addition or an image combining, and one of the processing units, which is to perform the specified video effect addition or image combining, is selected and performs the video editing on AV data decoded by the decoders 121 and 122.

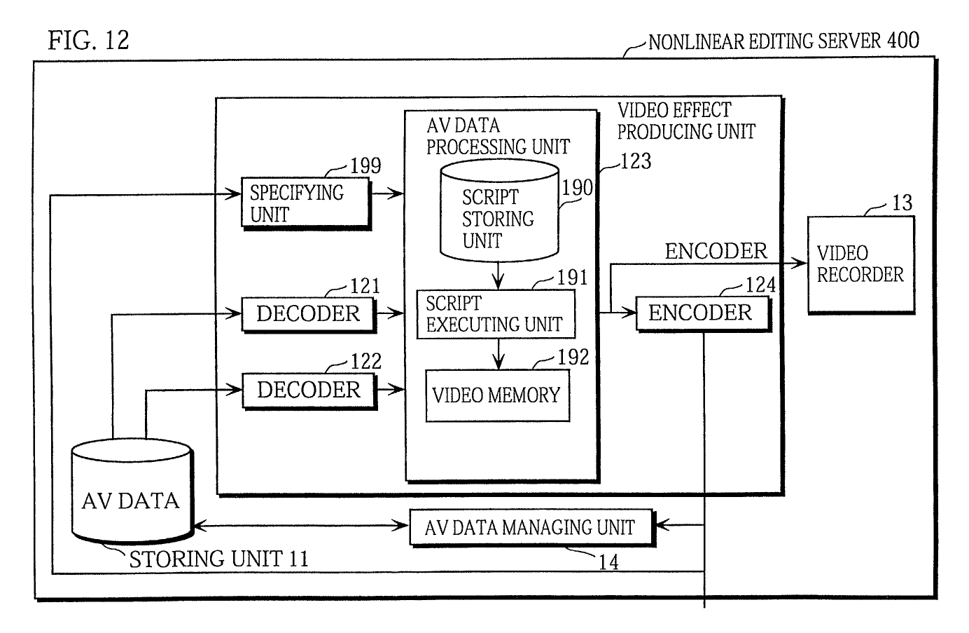

FIG. 12 shows the other example construction of the AV data processing unit 123 achieved by a general-purpose processing device. As shown in the figure, the AV data processing unit 123 includes the following elements: an effect script storing unit 190 for storing scripts that each define the content of a video effect addition or an image combining; video memory 192; and a script executing unit 191 for analyzing and executing a script. A specifying unit 199 specifies a type of a video effect addition or an image combining, and then the script executing unit 191 reads a script corresponding to the specified type from the script storing unit 190. The script executing unit 191 then executes the read script on AV data, which has been sent from the decoder 121 and/or the decoder 122 and placed in the video memory 192, to generate and output AV data on which the script has been executed.

### Second Embodiment

The second embodiment describes a nonlinear video editing system that comprises two types of servers composed of a content server for storing AV data and an effect processing server for performing video editing such as a video effect addition and an image combining although the first embodiment describes a nonlinear video editing system comprising a single server that stores AV data and also performs video editing.

### Overview of Nonlinear Video Editing System

The following briefly describes a function of each element of the nonlinear video editing system according to the present embodiment.

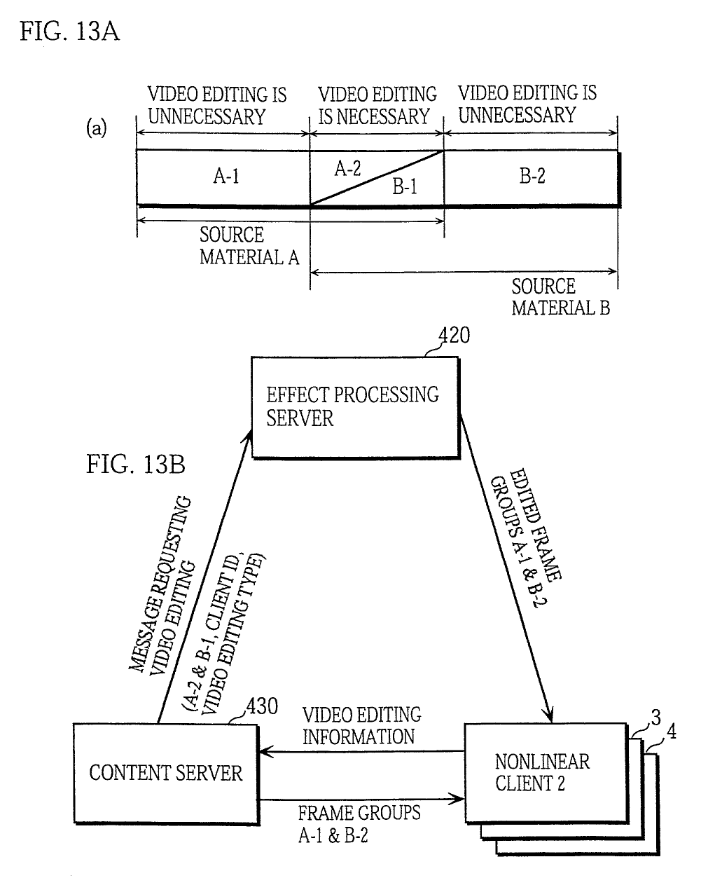

FIG. 13A shows a construction of AV files “A” and “B”, which are specified in video editing information. As shown in the figure, the AV file “A” (i.e., a source material “A”) is composed of a group of AV frames (hereafter a “frame group”) “A-1” and the other frame group “A-2”. The AV file “B” (i.e., a source material “B”) is composed of frame groups “B-1” and “B-2”. According to this video editing information, the frame group “A-1” is first presented, and then the frame groups “A-2” and “B-1” are presented together while a wipe transition from the group “A-2” to the group “B-1” is being made by gradually decreasing the ratio of a display of the frame group “A-2” to a display of the frame group “B-1”. After this, the frame group “B-2” is presented.

FIG. 13B shows a data flow of the present nonlinear editing system. As shown in the figure, in nonlinear clients 2-4 transmit video editing information like the above to a content server 430.

The content server 430 refers to the transmitted video editing information, and transfers frame groups “A-1”, and “B-2”, for which video editing is unnecessary, to each of the nonlinear clients 2-4 that transmitted the above video editing information. The content server 430 also generates a message requesting video editing. This message contains the following: a type of the requested video editing such as a video effect addiction and an image combining; and frame groups “A-2” and “B-1” for which the video editing should be performed. The content server 420 transmits the generated message to the effect processing server 420.

The effect processing server 430 receives this message, and adds a video effect corresponding to the video editing type, which is shown in the received message, to the frame groups in the received message, so that effect-added frame groups are generated. The effect processing server 420 then transmits the generated effect-added frame groups to the nonlinear client that has transmitted the above video editing information.

The nonlinear client receives the frame groups “A-1” and “B-2” from the content server 430 and the effect-added frame groups “A-2” and “B-1” from the effect processing server 420.

### Construction

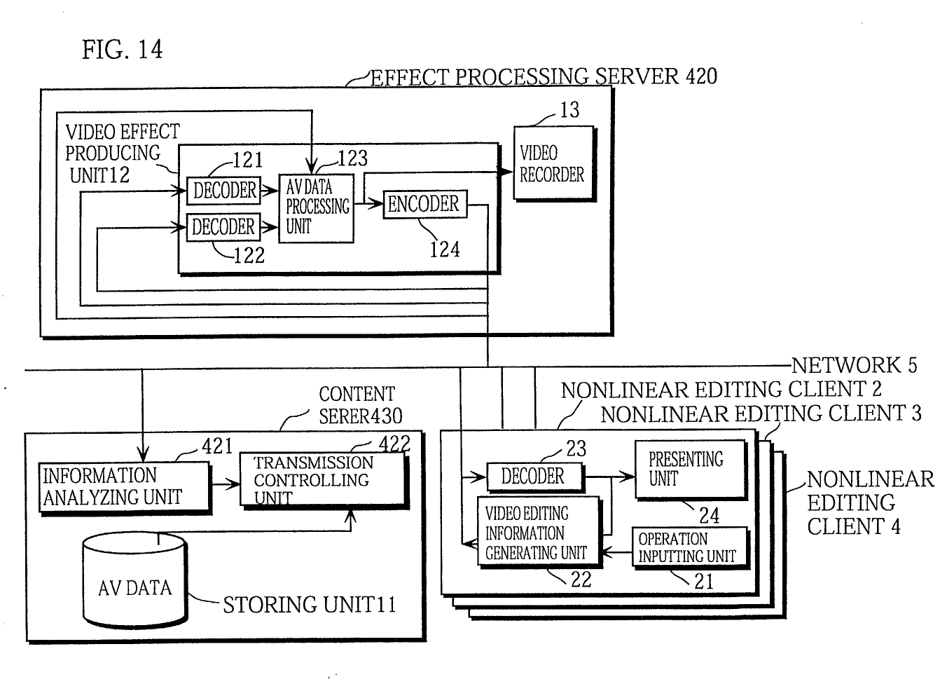

FIG. 14 is a block diagram showing a construction of the nonlinear video editing system of the present embodiment. The present video editing system differs from the editing system of the first embodiment shown in FIG. 3 in that the content server 430 of the present embodiment stores AV data and that the effect processing server 420 performs video editing such as a video effect addition and an image combining. The following describes constructions unique to the video editing system of the present embodiment.

A video editing information generating unit 22 in the nonlinear clients 2-4 generates video editing information, which is transmitted to the content server 430.

The content server 430 includes an information analyzing unit 421, a transmission controlling unit 422, and a storing unit 11 for storing AV data.

The information analyzing unit 421 analyzes video editing information which has been received, and specifies, out of frames specified in the analyzed video editing information, frames for which video editing should be performed as well as frames for which video editing is unnecessary. The information analyzing unit 421 then instructs the transmission controlling unit 422 to transfer the specified frames, for which video editing should be performed, to the effect processing server 420, and frames, for which no video editing is performed, to the client side.

The following specifically describes a case when video editing information shown in FIG. 5 is transmitted from the nonlinear client 2 to the content server 430 as one example.

As this video editing information shows that any video editing is not performed during a period from a time “00:00:00.00” to a time “00:00:13.29”, the information analyzing unit 421 instructs the transmission controlling unit 422 to directly transfer certain frames in a “VideoClip1” file stored in the storing unit 11 to the nonlinear client 2. The certain frames are consecutive frames that start with a frame specified by a frame number “00:00:40.03” and end with a frame specified by a frame number “00:00:54.02”.

During a period from a time “00:00:14.00” to a time “00:00:15.00”, a video effect addition should be performed. Accordingly, the information analyzing unit 421 instructs the transmission controlling unit 422 to transfer certain frames in the “VideoClip1” file and a “VideoClip2” to the effect processing server 420. The certain frames in the “VideoClip1” are consecutive frames that start with a frame specified by a frame number “00:00:54.03” and end with a frame specified by a frame number “00:00:55.03”. The specified frames in the “VideoClip2” file are consecutive frames that start with a frame specified by a frame number “50:00:00.00” and end with a frame specified by a frame number “51:00:00.00”.

During a period from a time “00:00:15.01” to a time “00:00:23.00”, video editing is unnecessary. Accordingly, the information analyzing unit 421 instructs the transmission controlling unit 422 to directly transfer certain frames in the “VideoClip2” file to the nonlinear client 2. The specified frames are consecutive frames that start with a frame specified by a frame number “00:00:51.01” and end with a frame specified by a frame number “00:00:59.00”.

The transmission controlling unit 422 reads AV data corresponding to frames specified in the video editing information from the storing unit 11. The transmission controlling unit 422 transmits the read AV data, for which video editing is unnecessary, to the nonlinear client 2 under control of the information analyzing unit 421. When the read AV data should be sent to the effect processing server 420, the transmission controlling unit 430 transmits a message, which contains the read AV data, an ID specifying the nonlinear client 2, and a video editing type indicating a type of a video effect or a type of an image combining method and requests video editing for this AV data.

### Operations

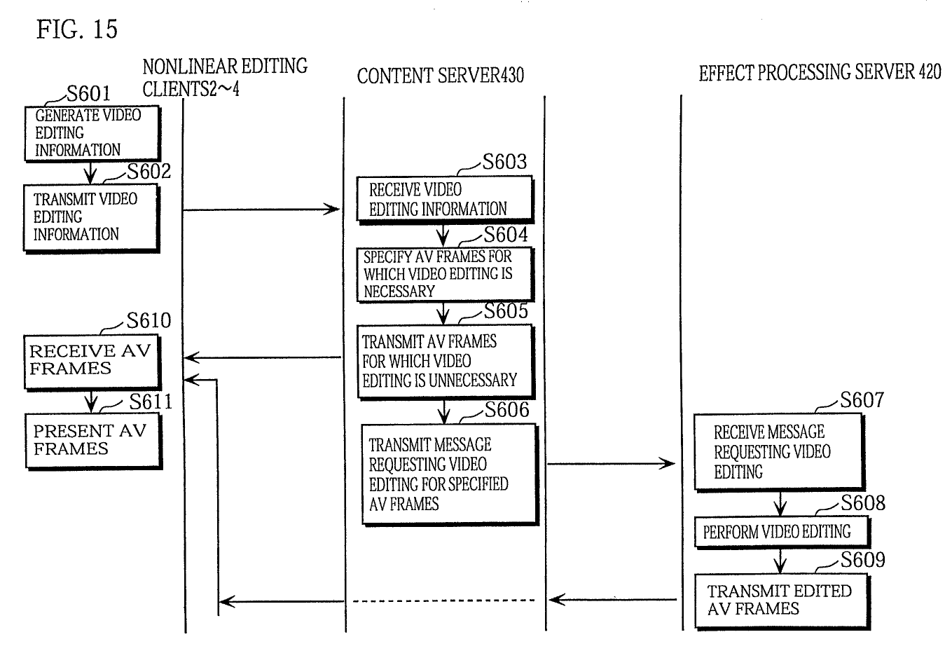

The following describes the processing of the above nonlinear video editing system with reference to the flowchart of FIG. 15. Here, assume that the nonlinear client 2 generates and transmits video editing information.

The video editing information generating unit 22 in the nonlinear client 2 generates video editing information (step S601).

The nonlinear client 2 then transmits the generated video editing information to the content server 430 (step S602).

The content server receives the video editing information (step S603).

The information analyzing unit 421 in the content server 430 analyzes the received video editing information and specifies AV frames for which video editing such as a video effect addition or an image combining should be performed as well as AV frames for which video editing is unnecessary (step S604).

The transmission controlling unit 422 reads the specified AV frames, for which no video editing is performed, from the storing unit 11, and transmits the read AV frames to the nonlinear client 2 (step S605).

The transmission controlling unit 422 reads the specified AV frames, for which video editing should be performed, from the storing unit 11, and generates a message which contains the read AV frames, an ID specifying the nonlinear client 2, and a video editing type to request the video editing for these AV frames. The transmission controlling unit 422 then transmits the generated message to the effect processing server 420 (step S606).

The effect processing server 420 then receives this message (step S607).

The video effect producing unit 12 in the effect processing server 420 performs the video editing for the AV frames contained in the received message in accordance with the video editing type shown in the message (step S608).

The effect processing server 420 transmits edited AV frames to the nonlinear client 2 (step S609).

The nonlinear client 2 receives the edited AV frames (step S610).

The nonlinear client 2 decodes the received AV frames and presents the decoded AV frames (step S611).

### Considerations

With the above nonlinear video editing system, the effect processing server 420 has a construction to perform video editing such as a video effect addition and an image combining. Accordingly, each nonlinear client does not need to have a construction to perform such video editing, so that the total cost of the nonlinear video editing system can be reduced. In addition, the present video editing system can flexibly respond to a newly-developed video editing method, such as a new method for providing a new video effect, by simply changing a construction of the effect processing server 420.

Further, with the present video editing system, the load can be shared to the content server 430 that stores AV data and to the effect processing server 440 that performs video editing, so that the load of the video editing system can be more reduced than when a single server is used in the editing system. Consequently, the present editing system can simultaneously process requests from a greater number of clients.

Moreover, two pieces of AV data are simultaneously carried only between the content server 430 and the effect processing server 420 through the network 5. This reduces the load of the network 5 between each nonlinear client and the content server 430, and between each nonlinear client and the effect processing server 420, as in the first embodiment.

In the above embodiment, the content server 430 receives video editing information from a nonlinear client, generates a message requesting video editing, and transmits this message to the effect processing server 420. However, the present invention is not limited to this, and the content server 430 may directly transmit the received video editing information to the effect processing server 420. From this video editing information, the effect processing server 420 may extract information that describes an effect addition or an image combining, and perform the effect addition or the image combining in accordance with the extracted information.

### Third Embodiment

The present embodiment relates to a nonlinear video editing system in which a server collectively manages an effect script and a client downloads the effect script from the server to perform video editing.

### Nonlinear Video Editing System

The following describes an overview of a nonlinear video editing system of the third embodiment.

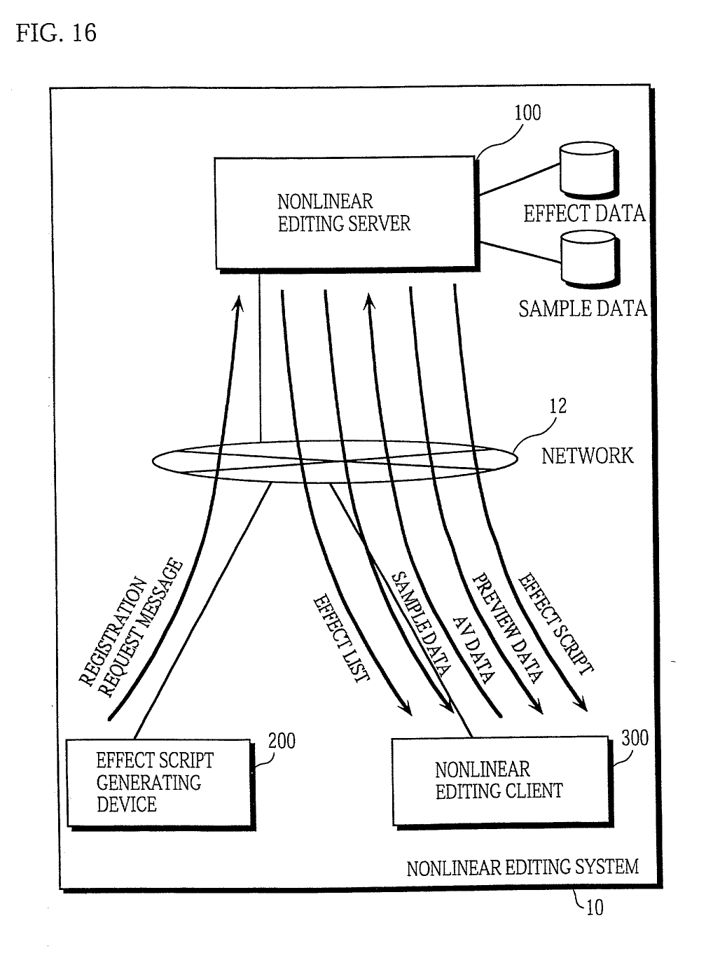

FIG. 16 is a block diagram showing a construction of the present nonlinear video editing system 10. The nonlinear video editing system 10 comprises a nonlinear editing server 100, an effect script generating device 200, a nonlinear editing client 300, and a network 12.

The nonlinear editing server 100 stores the following: effect scripts that each describe a procedure to add a video effect to video data; an effect script list showing information on the stored effect scripts; and sets of sample data that have each been generated by adding a video effect to predetermined video data. The nonlinear editing server 100 generates preview data by adding a video effect to video data transmitted from the nonlinear editing client 300.

The effect script generating device 200 generates an effect script, and transmits the generated effect script to the nonlinear editing server 100.

The nonlinear editing client 300 obtains, from the nonlinear editing server 100, the effect script list, an effect script, sample data, and preview data, and performs editing based on the obtained information.

### Construction of Effect Script Generating Device

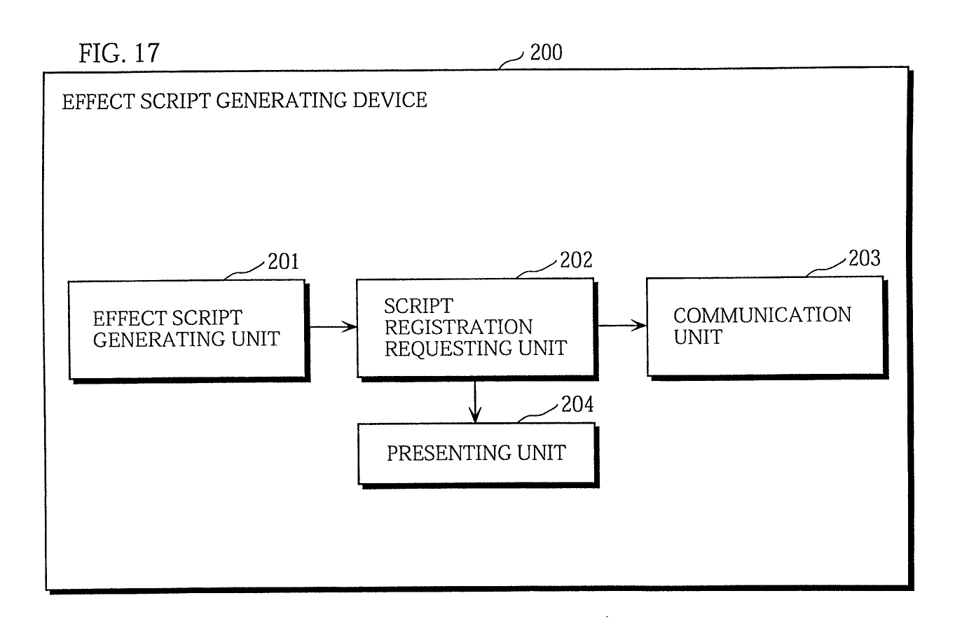

FIG. 17 is a block diagram showing a construction of the effect script generating device 200, which includes an effect script generating unit 201, a script registration requesting unit 202, a communication unit 203, and a presenting unit 204.

The effect script generating unit 201 generates an effect script.

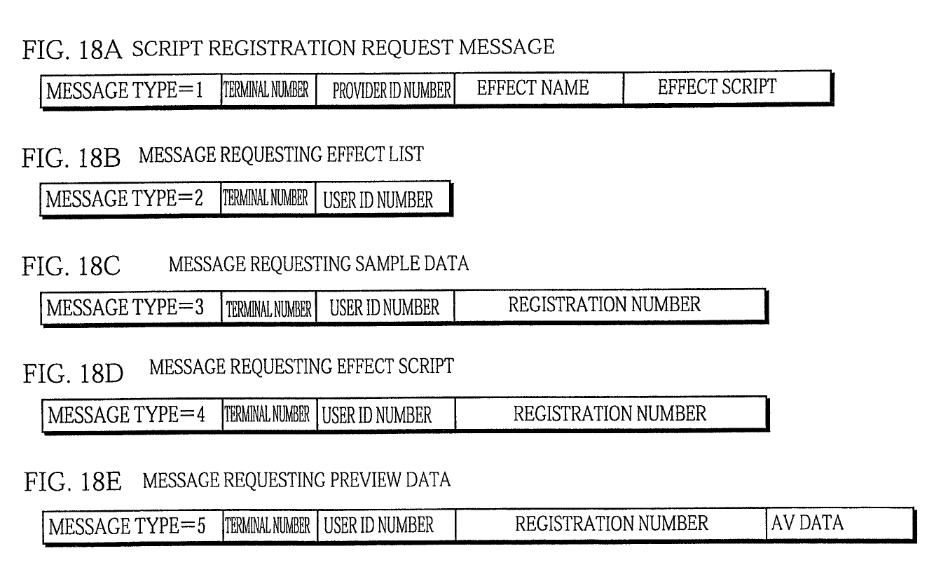

The script registration requesting unit 202 generates a registration request message as shown in FIG. 18A. The registration request message contains following information: a message type shown as “1”; a terminal number; a provider identification (ID) number; an effect name; and an effect script. The terminal number identifies the effect script generating device 200. The provider ID number identifies a user who provides the effect script contained in this registration request message. The effect name is shown as brief text that represents contents of the effect script, and is given by the user.

The communication unit 203 transmits a registration request message to the nonlinear editing server 100 via the network 12, and receives a response to this request message from the nonlinear editing server 100 via the network 12.

The presenting unit 204 presents a response message notifying that an effect script has been registered.

### Construction of Nonlinear Editing Client

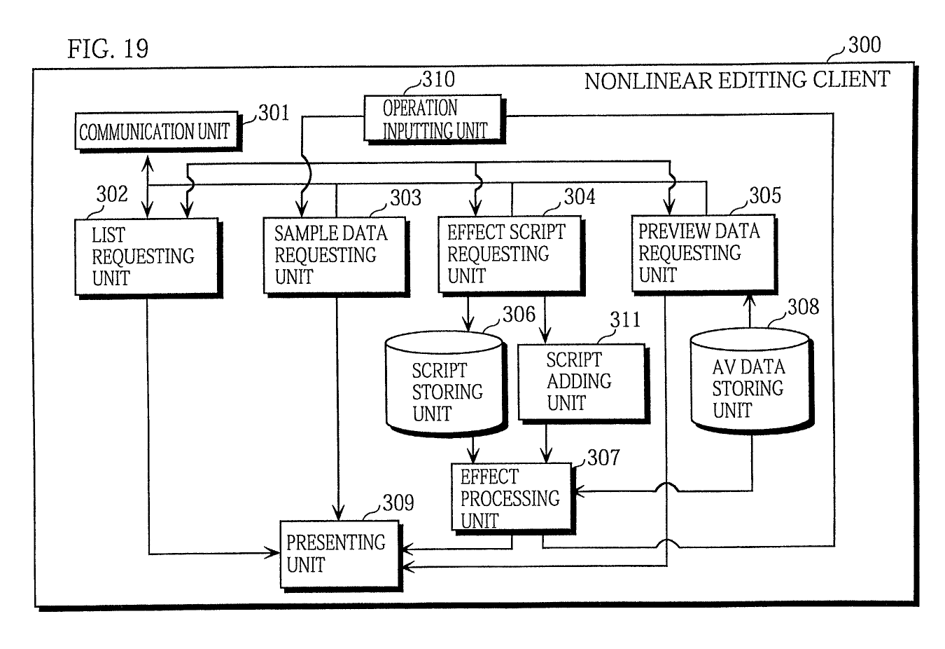

FIG. 19 shows a construction of the nonlinear editing client 300. The nonlinear editing client 300 includes a communication unit 301, an list requesting unit 302, a sample data requesting unit 303, an effect script requesting unit 304, a preview data requesting unit 305, a script storing unit 306, an effect processing unit 307, an AV data storing unit 308, a presenting unit 309, an operation inputting unit 310, and a script adding unit 311.

When receiving an input that requests an effect script list, the operation inputting unit 310 instructs the list requesting unit 302 to perform operations. When receiving an input that requests to obtain sample data and that designates a registration number of an effect script applied to the sample data, the operation inputting unit 310 instructs the sample data requesting unit 303 to perform operations. On receiving an input that requests an effect script and that designates a registration number of the effect script, the operation inputting unit 310 instructs the effect script requesting unit 304 to perform operations. On receiving an input that requests to obtain preview data and that designates AV data and a registration number of an effect script which are used for the preview data, the operation inputting unit 310 instructs the preview data requesting unit 305 to perform operations.

The communication unit 301 transmits a message requesting an effect script list, a message requesting sample data, a message requesting an effect script, and a message requesting preview data to the nonlinear editing server 100 via the network 12, and receives a response to each of these messages from the nonlinear editing server 100 via the network 12.

The list requesting unit 302 generates a message requesting an effect script list stored in the nonlinear editing server 100. As shown in FIG. 18B, this message contains the following information: a message type shown as “2”; a terminal number identifying the nonlinear editing client 300; and a user ID number identifying a user of the nonlinear editing client 300.

The sample data requesting unit 303 generates a message requesting sample data stored in the nonlinear editing server 100. As shown in FIG. 18C, this message contains the following information: a message type shown as “3”; a terminal number identifying the nonlinear editing client 300; a user ID number identifying a user of the nonlinear editing client 300; and a registration number of an effect script.

The effect script requesting unit 304 generates a message requesting an effect script stored in the nonlinear editing server 100. As shown in FIG. 18D, this message contains the following information: a message type shown as “4”; a terminal number identifying the nonlinear editing client 300; a user ID number identifying a user of the nonlinear editing client 300; and a registration number of the effect script. The effect script requesting unit 304 also places an effect script, which has been transmitted from the nonlinear editing server 100, into the effect script storing unit 306.

The preview data requesting unit 305 reads AV data, which has been designated via the operation inputting unit 310, from the AV data storing unit 308, and generates a message requesting preview data, which is to be generated by adding a designated effect script to the read AV data. As shown in FIG. 18E, this message contains the following information: a message type shown as “5”; a terminal number identifying the nonlinear editing client 300; a user ID number identifying a user of the nonlinear editing client 300; a registration number of the designated effect script; and the read AV data.

The effect script storing unit 306 stores an effect script which has been transmitted from the nonlinear editing server 100.

The AV data storing unit stores AV data.

When the user has selected AV data, and a type of an effect script out of a script menu, the effect processing unit 307 reads the selected AV data and the effect script from the AV data storing unit 308 and the effect script storing unit 308, respectively. The effect processing unit 307 then adds a video effect to the read AV data by executing the read effect script on the AV data. As a result, effect-added AV data is generated.

The script adding unit 311 adds an effect script, which has been transmitted from the nonlinear editing server 100, to the aforementioned script menu selectable by a user.

The presenting unit 309 presents an effect script list, preview data, and sample data which have been transmitted from the nonlinear editing server 100, effect-added AV data generated by the effect processing unit 307, and a message notifying that a requested effect script has been received.

### Construction of Nonlinear Editing Server

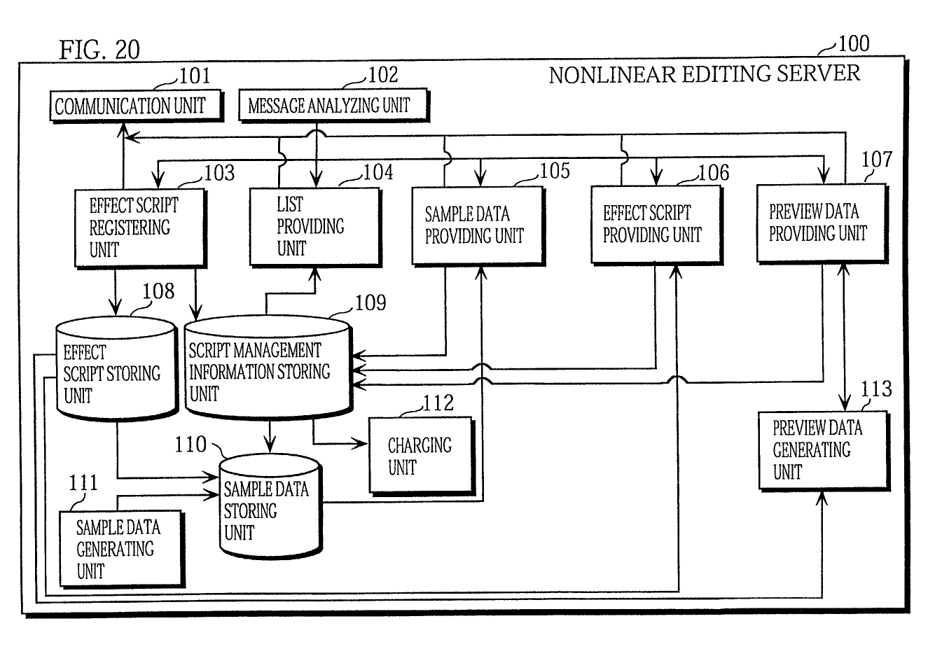

FIG. 20 is a block diagram showing a construction of the nonlinear editing server 100. The nonlinear editing server 100 includes a communication unit 101, a message analyzing unit 102, an effect script registering unit 103, a list providing unit 104, a sample data providing unit 105, an effect script providing unit 106, a preview data providing unit 107, an effect script storing unit 108, a script management information storing unit 109, a sample data storing unit 110, a sample data generating unit 111, a charging unit 112, and a preview data generating unit 113.

The communication unit 101 receives via the network 12 a message from the effect script generating device 200 and the nonlinear editing client 300, and transmits a response to this message via the network 12.

The message analyzing unit 102 analyzes a message received via the communication unit 101, and controls other units to perform operations in accordance with the analyzed message. In more detail, the message analyzing unit 102 instructs the following units to perform operations when the received message is analyzed as the following: the effect script registering unit 103 to perform operations when the received message is a registration request message; the list providing unit 104 to perform operations when the received message is a message requesting an effect script list; the effect script providing unit 106 when the received message is a message requesting an effect script; the preview data providing unit 107 when the received message is a message requesting preview data; and the sample data providing unit 105 when the received message is a message requesting sample data.

The effect script storing unit 108 stores an effect script which has been transmitted by the effect script generating device 200.

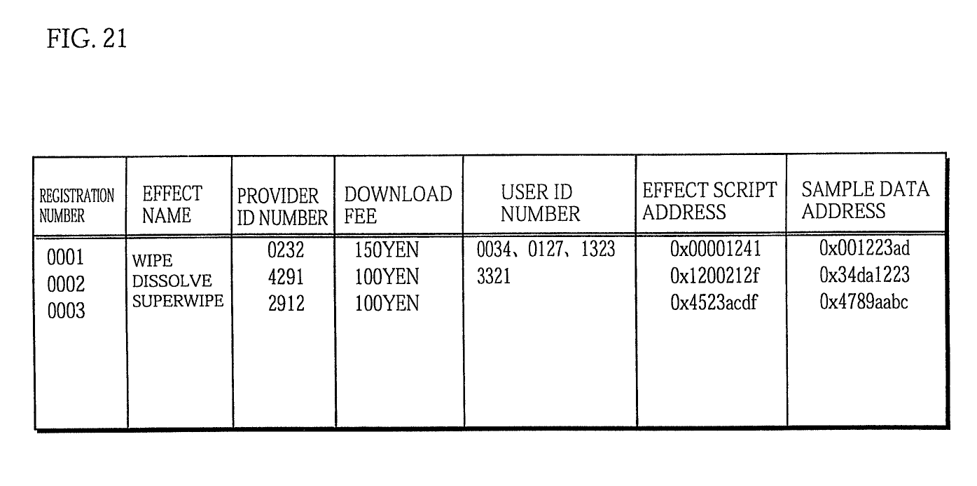

The script management information storing unit 109 stores effect script management information. FIG. 21 shows an example of the effect script management information. As shown in the figure, the effect script management information contains the following items, which are associated with one another, for each effect script: a registration number assigned to the effect script in an order of registration of the effect script; an effect name for the effect script; a provider ID number identifying a user who has provided this effect script; a download fee that is charged when this effect script is downloaded; a user ID number that identifies a user who has used this effect script; an effect script address that is an address of this effect script in the effect script storing unit 108; and a sample data address that is an address of sample data, to which this effect script is applied, in the sample data storing unit 110.

The effect script registering unit 103 refers to a received registration request message, and specifies the effect script generating device 200 and a provider (a user) that have transmitted the request message, using a terminal number and a provider ID number contained in the received message. The effect script registering unit 103 then extracts an effect script from the received message, and places the extracted effect script into the effect script storing unit 108.

Based on this received message, the effect script registering unit 103 also updates the effect script management information in the script management information storing unit 109. More specifically, the effect script registering unit 103 assigns a registration number to the effect script contained in the message, and writes the following effect script management information associated with the registration number: the effect name and the provider ID number contained in the received message; a download fee which is a default value of, for instance, 100 yen; and an effect script address for the effect script. This effect script management information does not contain a user ID number since nobody has used this effect script yet.

The effect script registering unit 103 also generates a response message that notifies the provider (user) that a registration of the transmitted effect script has been completed.

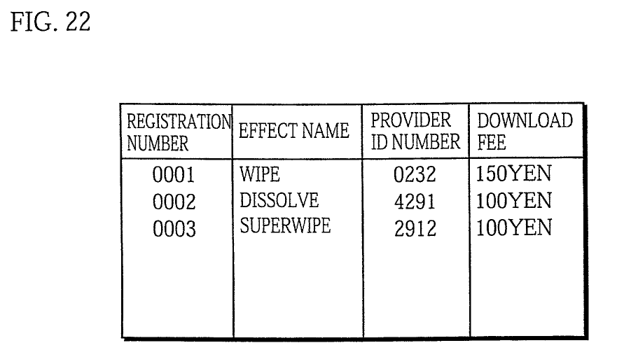

The list providing unit 104 refers to a received message requesting an effect script list, and specifies, using a terminal number and a user ID number in the received message, the nonlinear editing client 300 and a user that have transmitted this message. The list providing unit 104 then reads the effect script list, which is part of the effect script management information, from the script management information storing unit 109, and generates a response message containing the read effect script list. FIG. 22 shows an example of the effect script list. As shown in the figure, the effect script list contains the following items for each effect script: a registration number; an effect name; a provider ID that identifies a user who has provided this effect script; and a download fee.

The sample data providing unit 105 refers to a terminal number and a user ID number in a received message requesting sample data, and specifies the nonlinear editing client 300 and a user that have transmitted this message. The sample data providing unit 105 then refers to the effect script management information in the script management information storing unit 109 to specify a sample data address for sample data to which an effect script identified by a registration number in the received message is applied. The sample data providing unit 105 then reads the sample data from the specified sample data address in the sample data storing unit 110, and generates a response message containing the read sample data.

The effect script providing unit 106 refers to a terminal number and a user ID number contained in a received message requesting an effect script, and specifies the nonlinear editing client 300 and a user that have transmitted the message. The effect script providing unit 106 then refers to the effect script management information in the script management information storing unit 109, and specifies an effect script address in the effect script storing unit 108 which stores the effect script identified by the registration number in the received message. The effect script providing unit 106 then reads the identified effect script from the specified effect script address, and generates a response message containing the read effect script.

The preview data providing unit 107 refers to a terminal number and a user ID number contained in a received message requesting preview data, and specifies the nonlinear editing client 300 and a user that have transmitted the message. The preview data providing unit 107 then sends AV data and a registration number contained in the received message to the preview data generating unit 113. The preview data providing unit 106 receives preview data from the preview data generating unit 113, and generates a response message containing this preview data.

The sample data generating unit 111 generates sample data to be presented to a user who wishes to view a result of execution of an effect script on AV data. The sample data generating unit 111 generates the sample data by executing an effect script stored in the effect script storing unit 108 on predetermined AV data, and stores the generated sample data into the sample data storing unit 110. The sample data generating unit 111 then writes a sample address storing the generated sample data into the script management information storing unit 109.

The sample data storing unit 110 stores the generated sample data.

The preview data generating unit 113 refers to the script management information storing unit 109 to specify an effect script address storing an effect script identified by a registration number contained in a received message that requests preview data. The preview data generating unit 113 then reads the specified effect script from the effect script address in the effect script storing unit 108, and executes the read effect script to process AV data contained in the received message to generate preview data. The preview data generating unit 113 then sends the generated preview data to the preview data providing unit 107.

The charging unit 112 generates charging information to charge an effect script to a user who has downloaded the effect script and to have a fee of the effect script paid to a provider (user) of the effect script. In more detail, the charging unit 112 refers to the effect script management information, and generates the charging information showing that a download fee has been charged to users identified by user ID numbers shown in the effect script management information, and that each provider identified by an provider ID is paid a fee generated by multiplying a download fee by a total number of users who have downloaded an effect script provided by this provider.

### Effect Script Registration Processing

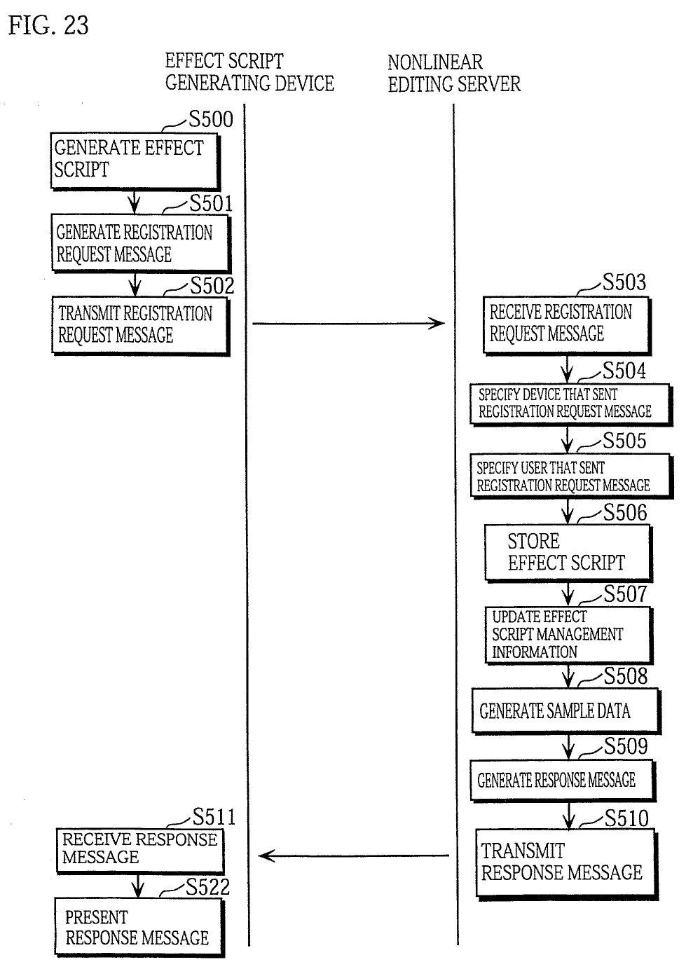

FIG. 23 shows a procedure to have the effect script generating device 200 transmit an effect script to the nonlinear editing server 100 and to have the nonlinear editing server 100 register the transmitted effect script.

The effect script generating unit 201 in the effect script generating device 200 generates an effect script (step S500).

The script registration requesting unit 202 in the effect script generating device 200 then generates a registration request message, as shown in FIG. 18A, which is composed of a message type shown as “1”, a terminal number, a provider ID number, an effect name, and the generated effect script (step S501).

The communication unit 203 in the effect script generating device 200 then transmits the generated registration request message to the nonlinear editing server 100 (step S502).

The nonlinear editing server 100 receives the registration request message via the communication unit 101, and this registration request message is analyzed by the message analyzing unit 102 and sent to the effect script registering unit 103 (step S503).

The effect script registering unit 103 specifies the effect script generating device 200 as the sender of the registration request message, using the terminal number in the received request message (step S504).

The effect script registering unit 103 then specifies a user as the sender of the request message, using a provider ID in the received message (step S505).

Following this, the effect script registering unit 103 extracts the effect script from the received registration request message, and stores it into the effect script storing unit 108 (step S506).

The effect script registering unit 103 updates the effect script management information in the script management information storing unit 109 in accordance with the received registration request message (step S507).

The sample data generating unit 111 executes this effect script on predetermined AV data to generate sample data, and places the generated sample data into the sample data storing unit 110. The sample data generating unit 111 then writes a sample data address storing this sample data into the script management information storing unit 109 (step S508).

After this, the effect script registering unit 103 generates a response message which is directed to the effect script generating device 200 and which indicates that the transmitted effect script has been registered (step S509).

The effect script registering unit 103 sends the generated response message to the communication unit 101, which then transmits the response message to the effect script generating device 200 (step S510).

The effect script generating device 200 receives this response message via the communication unit 203 (step S511).

The script registration requesting unit 202 in the effect script generating device 200 then has the presenting unit 204 present the received response message (step S512).

### Processing to Transfer Effect Script List

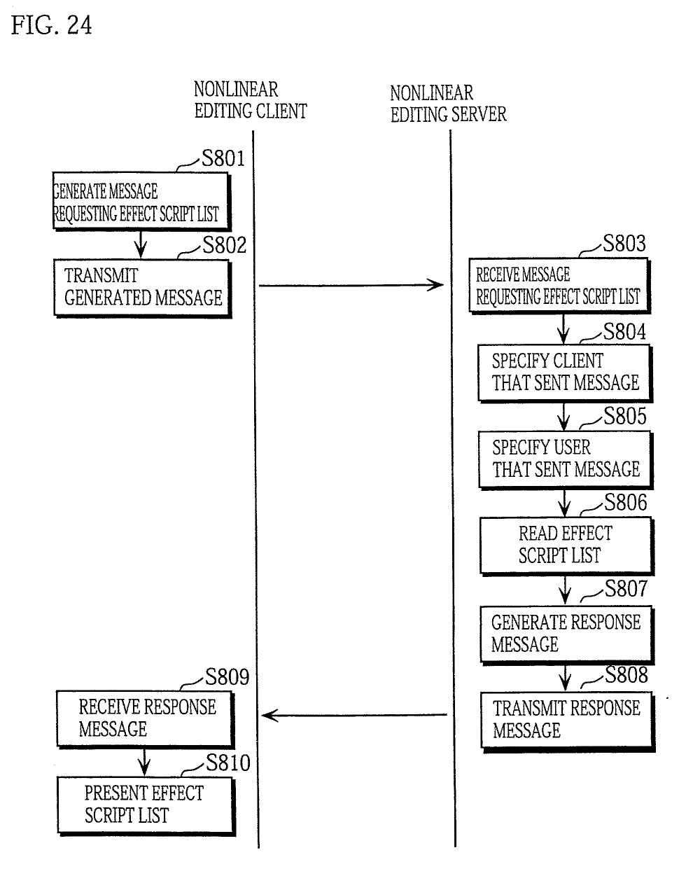

FIG. 24 shows a procedure to transfer an effect script list from the nonlinear editing server 100 to the nonlinear editing client 300.

The operation inputting unit 310 in the nonlinear editing client 300 receives an input that requests an effect script list, so that the list requesting unit 302 generates a message requesting the effect script list. This message is composed of a message type shown as “2”, a terminal number, and a user ID number, as shown in FIG. 18B (step S801).

The nonlinear editing client 300 then has the communication unit 301 transmit the generated message to the nonlinear editing server 100 (step S802).

The nonlinear editing server 100 receives this message via the communication unit 101, and the received message is analyzed by the message analyzing unit 102 and sent to the list providing unit 104 (step S803).

The list providing unit 104 specifies the nonlinear editing client 300 as the sender of this message using the terminal number contained in the message (step S804).

The list providing unit 104 then specifies a user identified by the user ID number contained in the received message as the sender of the message (step S805).

The list providing unit 104 then obtains an effect script list, which is part of the effect script management information (step S806).

The list providing unit 104 then generates a response message containing the obtained effect script list (step S807).

The nonlinear editing server 100 then has the communication unit 101 transmit the obtained effect script list to the nonlinear editing client 300 that has sent the message requesting the effect script list (step S808).

The nonlinear editing client 300 then receives this response message via the communication unit 301 (step S809).

The nonlinear editing client 300 then has the presenting unit 309 present the effect script list contained in the received response message (step S810).

### Processing to Transfer Sample Data

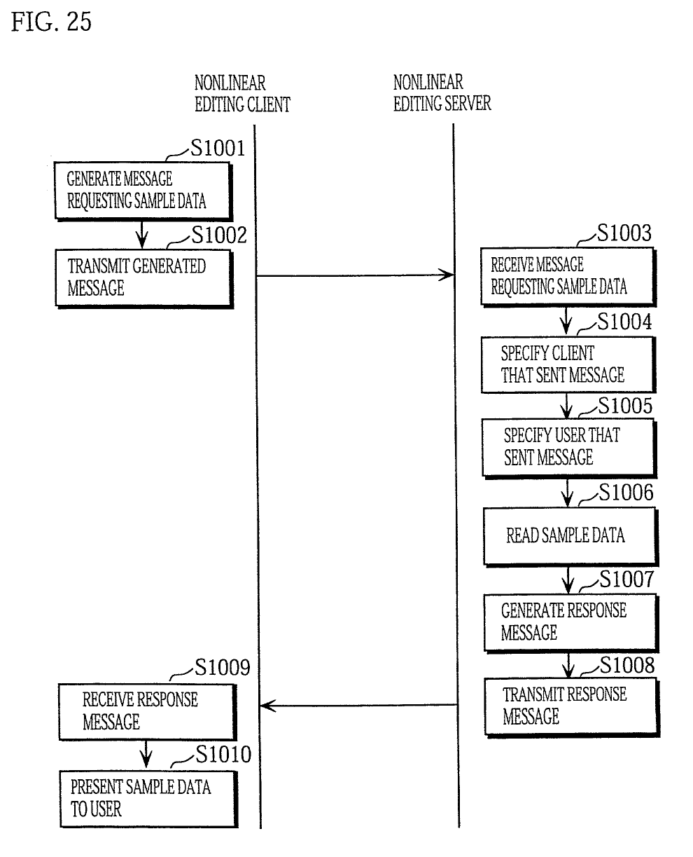

FIG. 25 shows a procedure to transfer sample data from the nonlinear editing server 100 to the nonlinear editing client 300.

The operation inputting unit 310 in the nonlinear editing client 300 receives an input that requests sample data, so that the sample data requesting unit 303 generates a message requesting the sample data. This message is composed of a message type shown as “3”, a terminal number, a user ID number, and a registration number of an effect script, as shown in FIG. 18C (step S1001).

The nonlinear editing client 300 then has the communication unit 301 transmit the generated message to the nonlinear editing server 100 (step S1002).

The nonlinear editing server 100 receives this message via the communication unit 101. The received message is analyzed by the message analyzing unit 102 and sent to the sample data providing unit 105 (step S1003).

The sample data providing unit 105 specifies the nonlinear editing client 300 as the sender of this message, using the terminal number contained in the message (step S1004).

The sample data providing unit 105 then specifies a user identified by the user ID number contained in the received message as the sender of the message (step S1005).

The sample data providing unit 105 then refers to the script management information storing unit 109, specifies a sample data address, which is associated with the registration number contained in the received message, and reads the sample data from the specified sample data address in the sample data storing unit 110 (step S1006).

The sample data providing unit 105 then generates a response message containing the read sample data (step S1007).

The nonlinear editing server 100 then has the communication unit 101 transmit the generated response message to the nonlinear editing client 300 that has sent the message requesting the sample data (step S1008).

The nonlinear editing client 300 then receives this response message via the communication unit 301 (step S1009).

The nonlinear editing client 300 then has the presenting unit 309 present the sample data contained in the received response message (step S1010).

### Processing to Transfer Effect Script

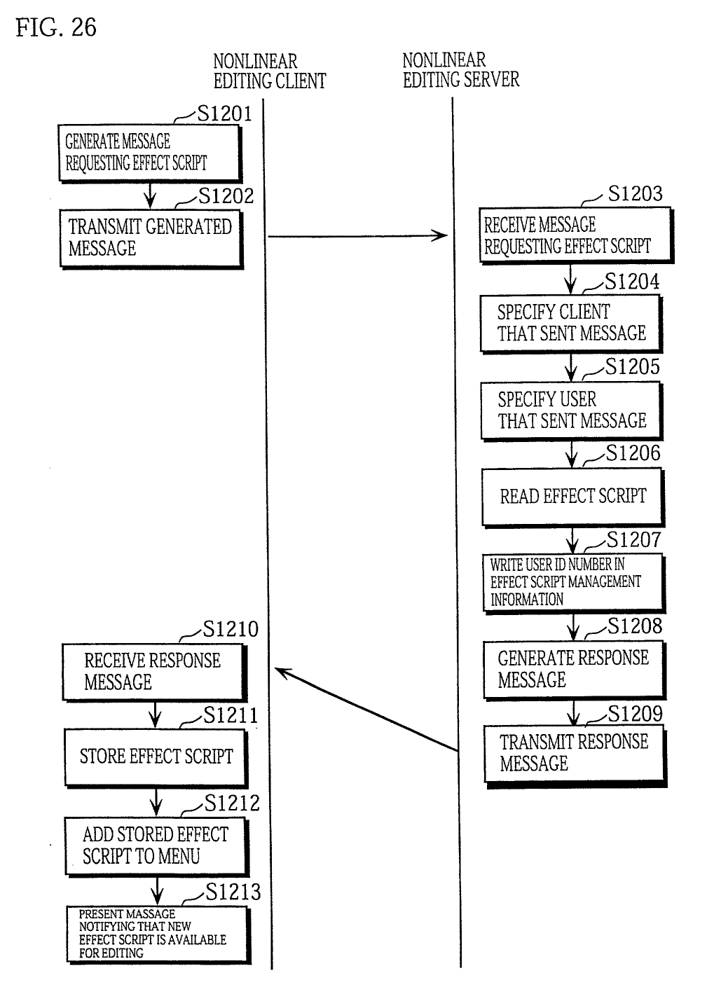

FIG. 26 shows a procedure to transfer an effect script from the nonlinear editing server 100 to the nonlinear editing client 300.

The operation inputting unit 310 in the nonlinear editing client 300 receives an input that requests an effect script, so that the effect script requesting unit 304 generates a message requesting the effect script. This message is composed of a message type shown as “4”, a terminal number, a user ID number, and a registration number of the effect script, as shown in FIG. 18D (step S1201).

The nonlinear editing client 300 then has the communication unit 301 transmit the generated message to the nonlinear editing server 100 (step S1202).

The nonlinear editing server 100 receives, via the communication unit 101, this message requesting the effect script. The received message is analyzed by the message analyzing unit 102 and sent to the effect script providing unit 106 (step S1203).

The effect script providing unit 106 specifies the nonlinear editing client 300 as the sender of this message, using the terminal number contained in the message (step S1204).

The effect script providing unit 106 then specifies a user identified by the user ID number contained in the received message as the sender of the message (step S1205).

The effect script providing unit 106 then refers to the script management information storing unit 109, specifies an effect script address associated with the registration number contained in the received message, and reads the effect script from the specified effect script address in the effect script storing unit 108 (step S1206).

The effect script providing unit 106 then writes the user ID number contained in the received message into a user ID number field associated with the read effect script in the effect script management information stored in the script management information storing unit 109 (step S1207).

The effect script providing unit 106 then generates a response message containing the read effect script (step S1208).

The nonlinear editing server 100 then has the communication unit 101 transmit the generated response message to the nonlinear editing client 300 that has sent the message requesting this effect script (step S1209).

The nonlinear editing client 300 receives this response message via the communication unit 301 (step S1210).

The effect script requesting unit 304 then places the effect script contained in the received response message into the effect script storing unit 306 (step S1211), and the effect script adding unit 311 adds this effect script to the script menu selectable by the user (step S1212).

The effect script requesting unit 304 then has the presenting unit 309 present a message notifying that the requested effect script has been obtained and is available for an editing operation (step S1213).

### Processina to Transfer Preview Data

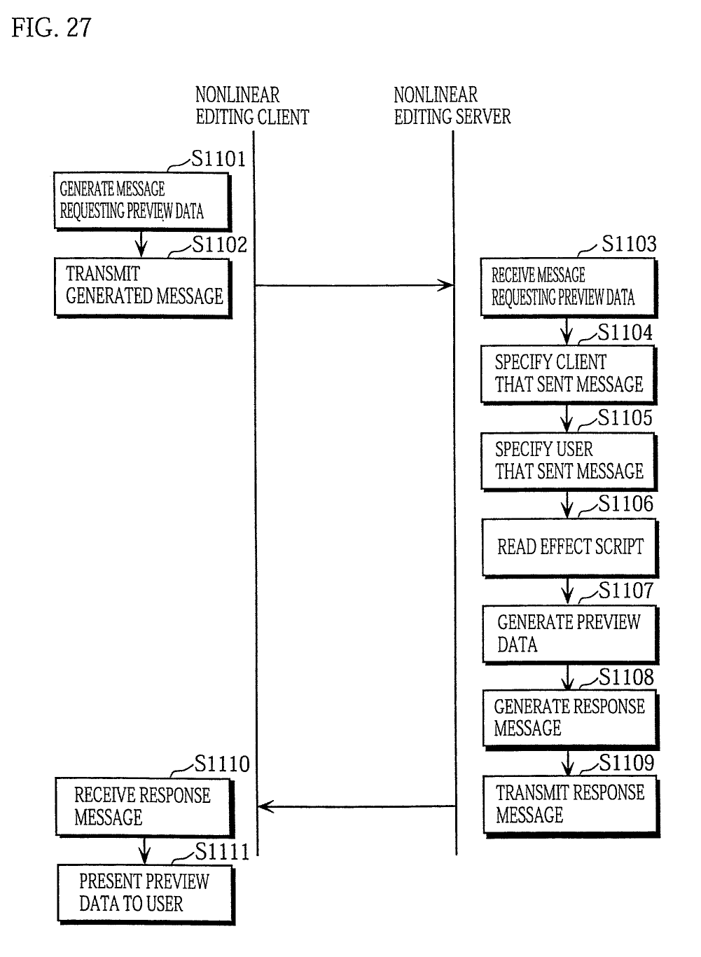

FIG. 27 shows a procedure to transfer preview data from the nonlinear editing server 100 to the nonlinear editing client 300.

The operation inputting unit 310 in the nonlinear editing client 300 receives an input that requests preview data and that designates AV data and a registration number of an effect script, so that the preview data requesting unit 305 reads the designated AV data from the AV data storing unit 308, and generates a message requesting the preview data. This message is composed of a message type shown as “5”, a terminal number, a user ID number, a registration number of the effect script, and the read AV data, as shown in FIG. 18E (step S1101).

The nonlinear editing client 300 then has the communication unit 301 transmit the generated message to the nonlinear editing server 100 (step S1102).

The nonlinear editing server 100 receives, via the communication unit 101, this message requesting the preview data. The received message is analyzed by the message analyzing unit 102 and sent to the preview data providing unit 107 (step S1103).

The preview data providing unit 107 specifies the nonlinear editing client 300 as the sender of this message, using the terminal number contained in the received message (step S1104).

The preview data providing unit 107 then specifies a user identified by the user ID number contained in the received message as the sender of the message (step S1105).

The preview data providing unit 107 then sends the AV data and the registration number, which are contained in the received message, to the preview data generating unit 113. The preview data providing unit 107 then refers to the script management information storing unit 109 to specify an effect script address associated with the registration number in the received message, and reads the effect script from the specified effect script address in the effect script storing unit 108 (step S1106).

The preview data generating unit 113 then executes the read effect script on the AV data contained in the received message, so that preview data is generated (step S1107).

The preview data providing unit 107 then generates a response message containing the generated preview data (step S1108).

The nonlinear editing server 100 then has the communication unit 101 transmit the generated response message to the nonlinear editing client 300 that has sent the message requesting this preview data (step S1109).

The nonlinear editing client 300 receives this response message via the communication unit 301 (step S1110).

The nonlinear editing client 300 then has the presenting unit 309 present the preview data contained in the received response message (step S1111).

### Considerations

With the nonlinear editing system of the present embodiment, the server stores effect scripts and transmits an effect script to a client in accordance with a request from the client. The client can add a video effect by executing the transmitted effect script, and therefore does not need to have a different dedicated device for each video effect type. Moreover, every client can use a newly-developed effect script when this effect script is only registered in the server.

Further, a power user and a manufacture can make a profit by registering an effect script he has developed into the server to allow other users to use the registered effect script. In this way, the present nonlinear editing system is useful for a power user and a manufacturer.

### Example Modifications

(1) Functions to Use and Generate Effect Script

In the third embodiment, a function to use an effect script and a function to generate an effect script are performed by the effect script generating device 200 and the nonlinear editing client 300, respectively. However, the effect script generating device 200 and the nonlinear editing client 300 may each perform both of the two functions.

(2) Download Fee

A download fee of the third embodiment for an effect script may be raised when a total number of users who have used the effect script reaches a predetermined number.

(3) AV Data

In the third embodiment, AV data used in the above nonlinear editing system is not encoded. This AV data, however, may be encoded. In this case, with the nonlinear editing client 300, the AV data storing unit 308 stores encoded AV data, which is decoded before being presented or processed. The nonlinear editing server 100 then receives a message, which requests preview data and contains encoded AV data, and decodes this encoded AV data to generate decoded AV data to add a video effect to the decoded AV data. The nonlinear editing server 100 then encodes this effect-added AV data, and transmits it to the nonlinear editing client 300.

(4) Execution of Effect Script

In the above embodiment, execution of an effect script is performed mainly by the nonlinear editing client 300, and the nonlinear editing server 100 executes an effect script only when generating preview data. The editing server 100, however, may execute an effect script on receiving a message, which specifies AV data and a type of a video effect to request an effect addition to the specified AV data, and may transmit the effect-added AV data to a client who has sent the message.

(5) Effect Script Management Information

In the third embodiment, a provider ID number and a user ID number are contained in the effect script management information and used for charging operations. However, information to be used for the charging operations and contained as the effect script management information is not limited to the above. For instance, it is possible to use a terminal number of the effect script generating device 200 used by a provider and that of the nonlinear editing client 300 used by a user, instead of a provider ID number and a user ID number, respectively. It is alternatively possible to use all the above four types of information, namely a user ID number, a provider ID number, and terminal numbers of the effect script generating device 200 and the nonlinear editing client 300 and to include them in the effect script management information.

(6) Other Modification

The first to third embodiments describe a nonlinear video editing system according to the present invention. It should be clear, however, that the present invention may be also applied to a linear video editing system and to an editing system for a still picture.

What is claimed is:

1. An editing server included in an audio/video (AV) editing system, which includes a plurality of clients that are connected via a network to the editing server, the editing server including:
editing information receiving means for receiving editing information from a client out of the plurality of clients, wherein the editing information specifies at least one AV stream, at least one frame contained in the at least one AV stream, and an editing operation which contains at least one of (a) a combining of each specified frame, and (b) an addition of a special effect to each specified frame;
AV stream obtaining means for obtaining each specified AV stream;
editing means for performing the editing operation for the obtained AV streams in accordance with the received editing information; and
transmitting means for transmitting each AV stream, for which the editing operation has been performed, to the client.

2. The editing server of claim 1, further including
AV stream storing means for storing at least one AV stream,
wherein when the received editing information specifies at least two AV streams, at least two video frames in the at least two AV streams, and the combining as the editing operation, the AV stream obtaining means reads the at least two specified AV streams from the AV stream storing means, and
wherein the editing means performs the editing operation by combining the at least two specified video frames contained in the at least two read AV streams to generate an AV stream.

3. The editing server of claim 2,
wherein as a result of the combining, the editing means generates a combined video frame, and reduces a resolution of the combined video frame.

4. The editing server of claim 1, further including
AV stream storing means for storing at least one AV stream,
wherein when the received editing information specifies the addition as the editing operation, the AV stream obtaining means reads the at least one specified AV stream from the AV stream storing means, and
wherein the editing means performs the editing operation by adding a special effect to each specified frame contained in the at least one read AV stream.

5. The editing server of claim 1,
wherein when the received editing information specifies the addition as the editing operation, the AV stream obtaining means receives the at least one specified AV stream from the client who sends the editing information, and
wherein the editing means performs the editing operation by adding a special effect to each specified frame contained in the at least one received AV stream.

6. An audio-video (AV) editing system which comprises the editing server of claim 1 and a plurality of clients that are connected via a network to the editing server,
wherein the plurality of clients each include:
editing information generating means for generating editing information, which specifies at least one AV stream, at least one frame contained in the at least one AV stream, and an editing operation which contains at least one of (a) a combining of each specified frame and (b) an addition of a special effect to each specified frame;
editing information transmitting means for transmitting the generated editing information to the editing server;
stream receiving means for receiving an AV stream, for which the editing operation has been performed, from the editing server; and
reproducing means for reproducing the received AV stream.

7. An editing server included in an audio/video (AV) editing system, which includes a content server and a plurality of clients, wherein the editing server, the content server, and the plurality of clients are connected via a network, the editing server including:
editing information receiving means for receiving editing information and a client number from the content server,
wherein the editing information specifies at least one AV stream and at least one frame contained in the at least one AV stream, and contains an instruction to perform at least one of (a) a combining of each specified frame, and (b) an addition of a special effect to each specified frame,
wherein the client number specifies a client to which an AV stream, for which the editing operation has been performed, is to be transmitted;
AV stream receiving means for receiving each specified AV stream from the content server, which stores an AV stream;
editing means for extracting the instruction from the received editing information, and performing, for the received AV streams, at least one of the combining and the addition in accordance with the extracted instruction; and
transmitting means for transmitting each AV stream, for which at least one of the combining and the addition has been performed, to the client specified by the client number.

8. A content server included in an audio/video (AV) editing system, which includes an editing server and a plurality of clients, wherein the editing server, the content server, and the plurality of clients are connected via a network, the content server including:
AV stream storing means for storing at least one AV stream;
editing information receiving means for receiving editing information from a client out of the plurality of clients,
wherein the editing information specifies at least one AV stream, at least one frame contained in the at least one AV stream, and an editing operation which contains at least one of (a) a combining of each specified frame, (b) an addition of a special effect to each specified frame, and (c) a transmission of each specified frame; and
transmitting means for reading each specified frame from the AV stream storing means, transmitting the read frame to the editing server if the specified editing operation is at least one of the combining and the addition, and transmitting the read frame to the client if the specified editing operation is the transmission.

9. An audio-video (AV) editing system which comprises a plurality of clients, the editing server of claim 7, and the content server of claim 8, all of which are connected via a network, wherein the plurality of clients each include:
editing information generating means for generating the editing information, which specifies at least one AV stream, at least one frame contained in the at least one AV stream, and an editing operation which contains at least one of (a) a combining of each specified frame, (b) an addition of a special effect to each specified frame, and (c) a transmission of each specified frame;
editing information transmitting means for transmitting the generated editing information to the content server;
receiving means for receiving an AV stream from one of the editing server and the content server; and
reproducing means for reproducing the received AV stream.

10. An editing server included in an audio/video (AV) editing system, which includes a plurality of editing clients connected via a network to the editing server, wherein each editing client performs editing for an AV stream by executing a script, wherein the editing server includes:
script storing means for storing a group of scripts that each describe a processing content for producing a special effect of a different type;
script request receiving means for receiving a request for a script from a client out of the plurality of clients, the request designating a type of the script; and
script transmitting means for reading the script of the designated type from the script storing means, and transmitting the read script to the client.

11. The editing server of claim 10, further including:
script list request receiving means for receiving a request for a script list from an editing client out of the plurality of editing clients, the script list showing information regarding the group of scripts stored in the script storing means;
script list storing means for storing the script list; and
script transmitting means for reading the script list from the script list storing means in response to the received request, and transmitting the read script list to the editing client.

12. The editing server of claim 10, further including:
sample data generating means for reading a script from the script storing means, and having the read script executed on a predetermined AV stream to generate sample data;
sample data request receiving means for receiving a request for sample data from an editing client out of the plurality of editing clients, the request designating a type of a script; and
sample data transmitting means for transmitting, to the editing client, the sample data generated by having the script of the designated type executed.

13. The editing server of claim 10, further including:
preview data request receiving means for receiving a request for preview data from an editing client out of the plurality of editing clients, the request containing an AV stream and designating a type of a script;
preview data generating means for reading the script of the designated type from the script storing means, and executing the read script on the AV stream contained in the received request to generate preview data; and
preview data transmitting means for transmitting the generated preview data to the editing client.

14. The editing server of claim 10,
wherein the AV editing system further comprises
a script generating client connected via the network to the editing server, and
wherein the editing server further includes:
a registration request receiving means for receiving a script from the script generating client; and
a script placing means for placing the received script into the script storing means.

15. The editing server of claim 14, further including:
usage information storing means for storing usage information which associates each script stored in the script storing means with an identifier (ID) of a provider who has transmitted the script, and with an ID of a user who has received the script; and
charging information generating means for generating, based on the usage information, charging information which associates each script stored in the script storing means with a first fee paid to a provider of the script and a second fee charged to a user of the script.

16. The editing server of claim 15,
wherein when the usage information associates a script with a larger total number of IDs of users, the charging information generating means generates the charging information associating the script with a larger first fee and a larger second fee.

17. An audio-video (AV) editing system which comprises a plurality of editing clients, the editing server of claim 10, and a script generating client, wherein the editing server is connected via a network to the script generating client and each editing client, wherein each editing client performs editing for an AV stream by executing a script and includes:
transmitting means for transmitting a request for a script to the editing server, the request designating a type of the script; and
receiving means for receiving the script of the designated type from the editing server,
wherein the script generating client includes:
script generating means for generating a script that describes a processing content for producing a special effect of one type; and
script transmitting means for transmitting the generated script to the editing server.

18. An editing method used by an editing server included in an audio/video (AV) editing system, which includes a plurality of clients that are connected via a network to the editing server, the editing method including:
an editing information receiving step for receiving editing information from a client out of the plurality of clients, wherein the editing information specifies at least one AV stream, at least one frame contained in the at least one AV stream, and an editing operation which contains at least one of (a) a combining of each specified frame, and (b) an addition of a special effect to each specified frame;
an AV stream obtaining step for obtaining each specified AV stream;
an editing step for performing the editing operation for the obtained AV streams in accordance with the received editing information; and
a transmitting step for transmitting each AV stream, for which the editing operation has been performed, to the client.

19. An editing method used by an editing server included in an audio/video (AV) editing system, which includes a content server and a plurality of clients, wherein the editing server, the content server, and the plurality of clients are connected via a network, the editing method including:
an editing information receiving step for receiving editing information and a client number from the content server,
wherein the editing information specifies at least one AV stream and at least one frame contained in the at least one AV stream, and contains an instruction to perform at least one of (a) a combining of each specified frame, and (b) an addition of a special effect to each specified frame,
wherein the client number specifies a client to which an AV stream, for which the editing operation has been performed, is to be transmitted;
an AV stream receiving step for receiving each specified AV stream from the content server, which stores an AV stream;
an editing step for extracting the instruction from the received editing information, and performing, for the received AV streams, at least one of the combining and the addition in accordance with the extracted instruction; and
a transmitting step for transmitting each AV stream, for which at least one of the combining and the addition has been performed, to the client specified by the client number.

20. An editing method used by a content server included in an audio/video (AV) editing system, which includes an editing server and a plurality of clients, wherein the editing server, the content server, and the plurality of clients are connected via a network, the editing method including:
an editing information receiving step for receiving editing information from a client out of the plurality of clients,
wherein the editing information specifies at least one AV stream, at least one frame contained in the at least one AV stream, and an editing operation which contains at least one of (a) a combining of each specified frame, (b) an addition of a special effect to each specified frame, and (c) a transmission of each specified frame; and
a transmitting step for reading each specified frame from AV stream storing means which stores at least one AV stream, transmitting the read frame to the editing server if the specified editing operation is at least one of the combining and the addition, and transmitting the read frame to the client if the specified editing operation is the transmission.

21. An editing method used by an editing server included in an audio/video (AV) editing system, which includes a plurality of editing clients connected via a network to the editing server, wherein each editing client performs editing for an AV stream by executing a script, wherein the editing method includes:
a script request receiving step for receiving a request for a script from a client out of the plurality of clients, the request designating a type of the script, the script describing a processing content for producing a special effect of one type;
a script transmitting step for reading the script of the designated type from script storing means which stores a script, and transmitting the read script to the client.

22. A computer-readable recording medium which stores a program to have a server computer perform editing, wherein the server computer is included in an audio/video (AV) editing system, which includes a plurality of client computers that are connected via a network to the server computer, the editing including:
an editing information receiving step for receiving editing information from a client computer out of the plurality of client computers, wherein the editing information specifies at least one AV stream, at least one frame contained in the at least one AV stream, and an editing operation which contains at least one of (a) a combining of each specified frame, and (b) an addition of a special effect to each specified frame;
an AV stream obtaining step for obtaining each specified AV stream;
an editing step for performing the editing operation for the obtained AV streams in accordance with the received editing information; and
a transmitting step for transmitting each AV stream, for which the editing operation has been performed, to the client computer.

23. A computer-readable recording medium which stores a program to have a server computer perform editing, wherein the server computer is included in an audio/video (AV) editing system, which includes a content computer and a plurality of client computers, wherein the server computer, the content computer, and the plurality of client computers are connected via a network, the editing including:
an editing information receiving step for receiving editing information and a client number from the content computer,
wherein the editing information specifies at least one AV stream and at least one frame contained in the at least one AV stream, and contains an instruction to perform at least one of (a) a combining of each specified frame, and (b) an addition of a special effect to each specified frame,
wherein the client number specifies a client computer to which an AV stream, for which the editing operation has been performed, is to be transmitted;
an AV stream receiving step for receiving each specified AV stream from the content computer, which stores an AV stream;
an editing step for extracting the instruction from the received editing information, and performing, for the received AV streams, at least one of the combining and the addition in accordance with the extracted instruction; and
a transmitting step for transmitting each AV stream, for which at least one of the combining and the addition has been performed, to the client computer specified by the client number.

24. A computer-readable recording medium which stores a program to have a content computer perform a predetermined operation, wherein the content computer is included in an audio/video (AV) editing system, which includes a server computer and a plurality of client computers, wherein the server computer, the content computer, and the plurality of client computers are connected via a network, wherein the predetermined operation includes:
an editing information receiving step for receiving editing information from a client computer out of the plurality of client computers,
wherein the editing information specifies at least one AV stream, at least one frame contained in the at least one AV stream, and an editing operation which contains at least one of (a) a combining of each specified frame, (b) an addition of a special effect to each specified frame, and (c) a transmission of each specified frame; and
a transmitting step for reading each specified frame from AV stream storing means which stores at least one AV stream, transmitting the read frame to the server computer if the specified editing operation is at least one of the combining and the addition, and transmitting the read frame to the client computer if the specified editing operation is the transmission.

25. A computer-readable recording medium which stores a program to have a server computer perform an editing operation, wherein the server computer is included in an audio/video (AV) editing system, which includes a plurality of client computers connected via a network to the server computer, wherein each client computer performs editing for an AV stream by executing a script, wherein the editing operation includes:
a script request receiving step for receiving a request for a script from a client computer out of the plurality of client computers, the request designating a type of the script, the script describing a processing content for producing a special effect of one type; and
a script transmitting step for reading the script of the designated type from script storing means which stores a script, and transmitting the read script to the client computer.
